(19) United States
(12) Patent Application Publication
(10) Pub. No.: US 2026/0200740 A1
(43) Pub. Date: Jul. 16, 2026

(54) GRAPHENE-SILICON COMPOSITE ELECTRODES AND A METHOD OF PREPARING SAME

(71) Applicant: Ramot at Tel-Aviv University Ltd., Tel-Aviv (IL)

(72) Inventors: Fernando PATOLSKY, Tel-Aviv (IL); Adam COHEN, Tel-Aviv (IL); Avinash KOTHURU, Tel-Aviv (IL); Gil DAFFAN, Tel-Aviv (IL)

(73) Assignee: Ramot at Tel-Aviv University Ltd., Tel-Aviv (IL)

(21) Appl. No.: 19/563,102

(22) Filed: Mar. 11, 2026

Related U.S. Application Data
(63) Continuation of application No. PCT/IL2024/050916, filed on Sep. 11, 2024.
(60) Provisional application No. 63/537,645, filed on Sep. 11, 2023.
(60) Provisional application No. 63/537,648, filed on Sep. 11, 2023.

(51) Int. Cl. C01B 32/184; H01M 4/02; H01M 4/04; H01M 4/36; H01M 4/38; H01M 4/66; H01M 10/0525

(52) U.S. Cl. CPC C01B 32/184; H01M 4/0404; H01M 4/0471; H01M 4/364; H01M 4/386; H01M 4/662; C01B 2204/22; C01P 2002/82; C01P 2002/85; C01P 2004/03; C01P 2004/04; C01P 2006/40; H01M 2004/021; H01M 2004/027; H01M 10/0525

(57) ABSTRACT

A method of preparing an electrochemically active component made of a 3D porous graphene matrix and electrochemically active material dispersed and/or entrapped within the matrix, and electrochemically active components obtained by this method are provided. The method is effected by depositing a mixture of a carbonaceous material and an electrochemically active material onto a conductive substrate, and exposing the conductive substrate to laser irradiation. Electrochemical systems integrating the electrochemically active component, for example, as an electrode such as an anode in alkali metal ion batteries and methods of preparing same are also provided.

### RELATED APPLICATIONS

This application is a Continuation of PCT Patent Application No. PCT/IL2024/050916 having International filing date of Sep. 11, 2024 which claims the benefit of priority under 35 USC § 119 (e) of U.S. Provisional Patent Application Nos. 63/537,645 and 63/537,648, both filed on Sep. 11, 2023.

PCT Patent Application No. PCT/IL2024/050916 also relates to co-filed PCT Patent Application No. PCT/IL2024/050917 entitled “JELLYFISH-DERIVED GRAPHENE STRUCTURE, METHODS OF PREPARING SAME AND USES THEREOF”, which claims the benefit of priority of U.S. Provisional Patent Application Nos. 63/537,645 and 63/537,648, both filed on Sep. 11, 2023.

The contents of the above applications are all incorporated by reference as if fully set forth herein in their entirety.

### FIELD AND BACKGROUND OF THE INVENTION

The present invention, in some embodiments thereof, relates to material science, and more particularly, but not exclusively, to graphene-silicon composite materials usable, for example, as electrodes, to methods of preparing same, and to uses thereof.

The demand for high-performance energy storage systems has increased significantly in recent years, driven by the widespread adoption of portable electronics and electric vehicles. Lithium-ion batteries have emerged as the primary choice to fuel these applications since their commercialization in 1991. These batteries operate through the movement of lithium ions between the anode and cathode during charging and discharging cycles. During charging, lithium ions are extracted from the cathode and intercalated into the anode, a process known as lithiation. When the battery discharges, the reverse process, de-lithiation, occurs as lithium ions move back to the cathode, releasing energy that powers devices. This fundamental chemistry, involving the transfer of lithium ions and electrons, is crucial for the battery's overall performance, including its capacity, energy density, and cycle life.

The typical anode in lithium-ion batteries is made of graphite, owing to its stability and low intercalation potential. However, graphite has a theoretical gravimetric capacity of only 372 mAh/g, which is not sufficient to meet the growing demand for higher-energy-density devices. Moreover, the cost of graphite is relatively high (from $2,000 to $5,000 per ton), which can significantly increase the cost of manufacturing. Additionally, the high demand for graphite in other industries, such as the steel industry, can cause supply shortages and price fluctuations, stirring further instabilities. Thus, global motivation has been fueled to explore alternatives for carbon as an anode material which does not suffer from the same shortcomings [a review by Claro et al. Appl. Phys. Rev. 9, 041305 (2022)].

Silicon has emerged as a highly promising anode material due to several advantages over carbon as an anode material for Lithium-ion batteries. Silicon has a higher theoretical specific capacity than carbon (>3579 mAh/g), which means that it can store significantly more lithium ions per gram of material. This enables higher energy densities and longer run times for the batteries. Further, silicon is extremely abundant and relatively inexpensive, making it an attractive alternative to other high-capacity anode materials.

However, some detrimental limitations have hindered the integration and commercialization of silicon anodes: silicon anodes undergo severe volume changes, which can reach about 400%, during the de-lithiation and lithiation processes that occur during operation of the Lithium-ion battery, which result in the pulverization of the active material, low coulombic efficiencies, uncontrolled growth of the solid electrolyte interface (SEI), and the loss of contact between the components and the current collector. See, for example, Chen et al. [Adv Mater. (2022) 34 (21), 2200894], teaching graphite carbon-containing composite silicon nanodots (NDs)/MOF anode for lithium-ion batteries. Obrovac and Christensen [Electrochem. Solid-State Lett. 7, (2004)] teach the structural changes in silicon electrochemically lithiated and de-lithiated at room temperature, and show that crystalline silicon becomes amorphous during lithium insertion, and that highly lithiated amorphous silicon suddenly crystallizes at 50 mV to form a lithium silicide phase (containing, e.g., Li₁₅Si₄). They also demonstrate that cycling silicon anodes above 50 mV avoids the formation of crystallized phases completely, resulting in better cycling performance.

Combining silicon and carbonaceous materials have been described, for example, in Wang et al. [Energy Storage Mater. (2020) 24 (24), 312-318], teaching the synthesis of a spherical Si/C composites anodes for lithium-ion batteries, having a low mechanical stability; Wang et al. [Carbon. (2022) 192, 277-284], teaching carbon-coated mesoporous silicon shell-encapsulated silicon nanograins as an anode material for lithium-ion batteries; Zhu et al. [Adv Funct Mater. (2021), 31 (33), 2101487], teaching microspheres of silicon in carbon nanospheres that are cross-linked with N-doped carbon fibers, as an anode material for lithium-ion batteries; Liu et al. [ACS Appl Mater Interfaces. (2023) 15 (7), 9457-9464], teaching silicon nanoparticles embedded in chemical-expanded graphite for lithium-ion batteries; and Luo et al. [ACS Sustainable Chem Eng. (2019) 7 (12), 10415-10424], teaching multi-layered mesoporous silicon/carbon core-shell composite nanospheres as anode material for lithium-ion batteries, prepared via a multi-step process that includes magnesium thermal reduction of mesoporous silica particles, followed by the polymerization of phenolic resin as a coating layer, then forming an interspace by chemically etching NiO nanocrystals, and finally adding a nitrogen-doped carbon layer to form the nanoparticles.

Carbonaceous matrices, including graphene, graphene nanosheets (GNs), and reduced graphene oxide (rGO), have been pursued as additives in silicon-based composite anodes of Lithium-ion batteries. These materials possess desirable chemical and physical properties, such as excellent mechanical flexibility, chemical stability, and electronic conductivity, which ultimately have shown partial success in overcoming the inherent challenges of Si-based anodes in Lithium-ion batteries.

Popular approaches to form these carbonaceous matrices rely on techniques such as chemical vapor deposition (CVD), mechanical peeling of bulk graphite, and reduction of graphene oxide. However, these methodologies are limited by insufficient suitability for bulk production, and by the extreme conditions (e.g., very high operating temperatures) and hazardous chemicals involved in the lengthy preparation processes [See, for example, a review by Duo et al. Electrochem. Energy Rev. 2, 149-198 (2019); a review by Shen et al. J. Energy Chem. 2018, 27, 1067-1090].

Laser irradiation can induce transformation of substrates such as polyimides to free-standing graphene in what is called Laser-Induced Graphene (LIG). Under ambient conditions, typically using a pulsed or continuous UV or CO₂ laser of varying wavelengths (e.g., from 400 nm to 10.6 micrometer), a highly disordered graphene-based substance can be created from different carbonaceous sources such as polyimide, PEEK22, and phenolic resins [Lin et al. Nat. Commun. 2014, 5, 5714; Stanford et al. ACS Appl Mater Interfaces. 2020, 12 (9), 10902-10907; Zhang et al. Carbon, 2018, 127, 287-296; a review by Guo et al. Nanomaterials 2022, 12 (14), 2336; a review by Scardaci, V. Appl. Sci. 2021, 11, 6304; Le et al. Adv. Funct. Mater. 2205158, 1-39 (2022)]. Carbon-containing molecules of such structures can be rearranged into the coveted hexagonal lattice by the high temperature and pressure conditions caused by localized laser irradiation, while excess material inherent to the precursor is released as gaseous by-products. This results in a highly porous network of interconnected LIG-domains [see, for example, a review by Alhajji et al. Energy Technol. 2021, 9, 1-15].

Minami et al. teach the formation of Si@C and SiC@C core-shell nanoparticles, which can be used as anode materials for lithium ion batteries, via pulsed laser irradiation-induced propagation of a tablet comprising a mixture of graphite and waste Si powders.

Additional background art includes Daffan et al. ChemRxiv, 1 (2024); Daffan et al. Journal of Energy Chemistry, 97, 553-565 (2024); Kothuru et al. Carbon Energy, 6 (7), e507 (2024); and Daffan et al. Advanced Energy Materials, 2401832 (2024).

### SUMMARY OF THE INVENTION

According to an aspect of some embodiments of the present invention there is provided a method of preparing an electrochemically active component, the method comprising: depositing at least one layer of a mixture comprising a carbonaceous material and an electrochemically active material onto a conductive substrate, to thereby obtain the conductive substrate having the at least one layer deposited on at least a portion of a surface thereof; and exposing the conductive substrate having the at least one layer deposited thereon to laser irradiation, to thereby form a 3D porous structure deposited onto the at least a portion of the surface of the conductive substrate, the 3D porous structure comprising a 3D porous graphene matrix having the electrochemically active material dispersed and/or entrapped therewithin, thereby preparing the electrochemically active component.

According to some of any of the embodiments described herein, the mixture features a consistency of a liquid or a semi-solid composition.

According to some of any of the embodiments described herein, the method further comprises, prior to the depositing, subjecting the mixture to homogenization.

According to some of any of the embodiments described herein, the depositing is by spin coating.

According to some of any of the embodiments described herein, the depositing is of two or more layers of the mixture.

According to some of any of the embodiments described herein, the method further comprises, subsequent to the depositing, heating the conductive substrate having the at least one layer deposited thereon.

According to some of any of the embodiments described herein, the heating is at a temperature in a range of from 40° C. to 100° C., and/or for a time period of at least 30 seconds, or at least 1 minute, or in a range of from 30 seconds to 1 hour.

According to some of any of the embodiments described herein, the heating is performed subsequent to depositing each of the at least one layers.

According to some of any of the embodiments described herein, the exposing is subsequent to depositing the two or more layers.

According to some of any of the embodiments described herein, a total thickness of the at least one layer ranges from 1 to 200 micrometers, or from 1 to 100 micrometers.

According to some of any of the embodiments described herein, the method further comprises, subsequent to the exposing, heating the conductive substrate having the 3D porous structure deposited thereon.

According to some of any of the embodiments described herein, the heating is at a temperature of at least 100° C. or at least 120° C. or at least 150° C., for example, in a range of from 100° C. to 250 15° C., or from 100° C. to 200° C., or is about 150° C., and/or for a time period of at least 1 minute, or at least 5 minutes, or at least 10 minutes, or at least 15 minutes, and up to 1 hour.

According to some of any of the embodiments described herein, the laser irradiation is performed at a wavelength in a range of from 400 to 700 nm, or from 400 to 500 nm, or of about 450 nm.

According to some of any of the embodiments described herein, the laser irradiation is performed at a power level of at least 2.0 W, or at least 2.5 W, or of about 2.8 W.

According to some of any of the embodiments described herein, the laser irradiation is performed for a time period of from 1 second to 30 second, or from 5 second to 30 seconds.

According to some of any of the embodiments described herein, the laser irradiation is performed at a fluence in a range of at least 3.5, or at least 4.0, or at least 4.4, and up to 50.0, J/cm².

According to some of any of the embodiments described herein, the electrochemically active material is in a form of a plurality of particles.

According to some of any of the embodiments described herein, the particles have an average diameter in a range of from 1 to 300 nm, or from 1 to 200 nm, or of about 100 nm.

According to some of any of the embodiments described herein, the electrochemically active material is or comprises silicon.

According to some of any of the embodiments described herein, the carbonaceous material is selected capable of transforming to graphene following the exposure to the laser irradiation.

According to some of any of the embodiments described herein, the carbonaceous material comprises at least one of a polymerizable small molecule material, a polymerizable and/or crosslinkable polymeric material (a resin), a synthetic polymeric material, a natural substance, and any combination thereof.

According to some of any of the embodiments described herein, the polymeric material is selected from a polyimide (PI), a polyetherimide (PEI), a polycarbonate (PC), a poly(ether ketone) (PEEK), a poly(alkylene glycol), a sulfonate poly(ether ketone) (SPEEK), a poly(methyl methacrylate) (PMMA), a polyacrylonitrile (PAN)), a polypyrrole, an aromatic thermoplastic polymer, and any combination thereof.

According to some of any of the embodiments described herein, the natural substance is selected from cellulose, a cellulose derivative, a hemicellulose, lignin, chitosan, sucrose, wheat starch, and any combination thereof.

According to some of any of the embodiments described herein, the carbonaceous material comprises a phenolic resin.

According to some of any of the embodiments described herein, the mixture comprises the electrochemically active material in an amount of at least 1%, or at least 5%, and up to 30%, by weight of a total weight of the mixture.

According to some of any of the embodiments described herein, the 3D porous graphene matrix is in a form of a continuous porous matrix.

According to some of any of the embodiments described herein, an overall porosity of the 3D porous structure ranges from 20 to 80, %, when analyzing a binary SEM image with a threshold of 127.

According to some of any of the embodiments described herein, a content of the electrochemically active material in the 3D porous structure ranges from 40 to 80, or from 50 to 70, or is about 68, % by weight of the total weight of the 3D porous structure.

According to some of any of the embodiments described herein, a carbon content of the 3D porous structure ranges from 10 to 40, or is about 25, % by weight of the total weight of the 3D porous structure.

According to some of any of the embodiments described herein, an oxygen content of the 3D porous structure ranges from 1 to 10, or is about 6, % by weight of the total weight of the 3D porous structure, indicative of the total amount of oxidized carbon and/or silicon species in the structure.

According to some of any of the embodiments described herein, a ratio of an intensity of D and G bands (ID/IG) of the 3D porous structure, as measured by Raman spectroscopy, is in a range of from 0.75 to 1.1.

According to some of any of the embodiments described herein, the conductive substrate comprises one or more of stainless steel, copper, and aluminum.

According to some of any of the embodiments described herein, the conductive substrate is a current collector.

According to some of any of the embodiments described herein, the 3D porous structure forms an electrode deposited on the current collector.

According to some of any of the embodiments described herein, the electrode is usable as an anode in a lithium-ion battery.

According to an aspect of some embodiments of the present invention there is provided an electrochemically active component obtained by the method as described herein in any of the respective embodiments and any combination thereof.

According to an aspect of some embodiments of the present invention there is provided an electrochemically active component comprising a 3D porous structure as described herein in any of the respective embodiments and any combination thereof, which comprises a continuous 3D porous graphene matrix as described herein having an electrochemically active material as described herein dispersed and/or embedded and/or entrapped therewithin.

According to some of any of the embodiments described herein, electrochemically active component further comprises a conductive substrate, as described herein, wherein the 3D porous structure is deposited onto at least a portion of a surface of the conductive substrate.

According to some of any of the embodiments described herein, electrochemically active component is or comprises an electrode.

According to some of any of the embodiments described herein, the conductive substrate is a current collector, and wherein the electrochemically active component is or comprises an electrode deposited on the current collector.

According to some of any of the embodiments described herein, an overall porosity of the 3D porous structure ranges from 20 to 80, %, when analyzing a binary SEM image with a threshold of 127.

According to some of any of the embodiments described herein, a content of the electrochemically active material in the 3D porous structure ranges from 40 to 80, or from 50 to 70, % by weight of the total weight of the continuous 3D porous graphene matrix.

According to some of any of the embodiments described herein, a carbon content of the 3D porous structure ranges from 10 to 40, or is about 25, % by weight of the total weight of the continuous 3D porous graphene matrix.

According to some of any of the embodiments described herein, an oxygen content of the 3D porous structure ranges from 1 to 10, or is about 6, % by weight of the total weight of the continuous 3D porous graphene matrix, indicative of the total amount of oxidized carbon and/or silicon species in the structure.

According to some of any of the embodiments described herein, a ratio of an intensity of D and G bands (ID/IG) of the 3D porous structure, as measured by Raman spectroscopy, is in a range of from 0.75 to 1.1.

According to some of any of the embodiments described herein, a total thickness of the 3D porous structure ranges from 1 to 200 micrometers, or from 1 to 100 micrometers.

According to some of any of the embodiments described herein, the continuous 3D porous graphene matrix is or comprises a laser-induced graphene.

According to some of any of the embodiments described herein, the laser-induced graphene is obtained by exposing a mixture comprising a carbonaceous material and particles of an electrochemically active material to a laser irradiation.

According to some of any of the embodiments described herein, the electrochemically active material is or comprises silicon, and the particles are or comprise silicon nanoparticles.

According to an aspect of some embodiments of the present invention there is provided an electrochemical system comprising the electrochemically active component as described herein in any of the respective embodiments and any combination thereof.

According to some of any of the embodiments described herein, the electrochemical system is or forms a part of an alkali metal ion battery.

According to some of any of the embodiments described herein, the electrochemical system further comprises an alkali metal ion cathode.

According to some of any of the embodiments described herein, the alkali metal ion cathode is a lithium ion cathode selected from NMC (lithium nickel manganese cobalt oxide, i.e., LiNiₓMn_{y}Co₂O₂) cathodes; lithium cobalt oxide (LiCoO₂) cathodes; NCA (lithium nickel cobalt aluminum oxide, i.e., LiNiCoAlO₂) cathodes; LMO (lithium manganese oxide, i.e., LiMn₂O₄) cathodes; LFP (lithium iron phosphate, i.e., LiFePO₄) cathodes; and lithium/sulfur cathodes.

According to some of any of the embodiments described herein, the lithium ion cathode is a lithium iron phosphate cathode.

According to some of any of the embodiments described herein, the electrochemical system further comprises an electrolyte.

According to some of any of the embodiments described herein, the electrolyte is or comprises LiPF₆.

According to some of any of the embodiments described herein, the electrochemical system is characterized by a cyclic stability of at least 1000, or at least 4000, or at least 4500, and up to 20,000, cycles.

According to some of any of the embodiments described herein, electrochemical system is characterized by an areal capacity in a range of at least 1.75, or at least 2.2, and up to 10.0, mAh/cm².

According to some of any of the embodiments described herein, the electrochemical system is characterized by a gravimetric capacity of at least 2000, or at least 2400, and up to 10,000, mAh/g.

According to some of any of the embodiments described herein, the electrochemical system is characterized by a Coulombic efficiency of at least 95, or at least 99, or at least 99.99, %.

According to some of any of the embodiments described herein, the electrochemical system is characterized by a C-rate of at least 3C, or at least 4C, and up to 10C.

According to some of any of the embodiments described herein, the electrochemical system is operable at a C-rate of 3C with an average Coulombic efficiency of at least 98%, or at least 99%.

According to some of any of the embodiments described herein, the electrochemical system is characterized by a capacity retention of at least 50, or at least 75, or at least 80, and up to 100, %.

According to an aspect of some embodiments of the present invention there is provided a method of preparing the electrochemical system as described herein in any of the respective embodiments, the method comprising: preparing the electrochemically active component according to the method as described herein in any of the respective embodiments; and integrating the electrochemically active component at least with a complementary electrode and an electrolyte, thereby preparing the electrochemical system.

According to some of any of the embodiments described herein, preparing the electrochemically active component is effected by additive manufacturing.

According to some of any of the embodiments described herein, each of the electrochemically active component and at least the complementary electrode and the electrolyte is prepared by additive manufacturing, either independently or altogether.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of an exemplary lasing procedure for forming graphene-silicon composite material according to some embodiments of the present invention, and a magnified, simplified, side-view illustration of the exemplary method and the composite material structure.

FIGS. 1B-C present representative HRSEM images (FIG. 1B) and cross-sectional HRSEM images (FIG. 1C) of a LIG/SiNP composite structure prepared from a mixture of AZ® 1518 (also referred to herein as “photoresist”), an exemplary carbonaceous material and silicon, an exemplary electrochemically active material, according to some of the present embodiments, spin coated on a stainless steel current collector following lasing at varying fluences (from 2.2 J/cm² to 5.5 J/cm², as indicated).

FIG. 1D presents top-view HRSEM images at different magnifications (500 μm, 2 μm, and 400 nm), as indicated, of an exemplary LIG/SiNP composite structure according to some of the present embodiments prepared by lasing, at fluence of 5.5 J/cm², a mixture of AZ® 1518, an exemplary carbonaceous material and silicon, an exemplary electrochemically active material, according to some of the present embodiments, spin coated on a stainless steel current collector, and a photograph of a bend and twisted strip of the electrode (inset, upper image).

FIG. 1E is a photograph showing pieces of a 10 cm aluminum foil spin-coated with a mixture of AZ® 1518 (also referred to herein as “photoresist”), an exemplary carbonaceous material and silicon nanoparticles, an exemplary electrochemically active material according to some of the present embodiments, pre-lasing (left) and post-lasing (right).

FIG. 1F presents photographs showing mechanical testing that include bending and twisting of a strip taken from the sample shown in FIG. 1E.

FIG. 1G presents a photograph (left) and an HRSEM image (right) of a scaled-up sample as presented in FIG. 1E) after bending, showing no damage to the lased material.

FIGS. 1H-I present a photograph of an experimental setup for measuring a reduction in carbon mass in an in-operando experiment in which a formed graphene matrix (without SiNP) is continuously weighed during the laser ablation process (FIG. 1H) and a plot presenting the data measured in this experiment (FIG. 1I).

FIGS. 1J-L present photographs showing an electrode prepared by doctor-blading a mixture of AZ® 1518 (also referred to herein as “photoresist”), as exemplary carbonaceous material and silicon, an exemplary electrochemically active material, according to some of the present embodiments, and depositing the mixture on Cu current collectors, before and after lasing (FIG. 1J), the mechanical (bending and twisting) testing of a strip from the formed electrode (FIG. 1K), and a plot showing electrochemical results of electrochemical cells comprising pre- and post-bending anodes.

FIG. 2A presents TEM images showing a composite sample after extraction of a lamella therefrom using focused ion beam (FIB) (left) and the extracted lamella from the sample (right). SS denotes stainless steel current collector and “W LAYER” denotes tungsten layer deposited by the FIB system to protect the sample during the preparation of the lamella.

FIG. 2B-C present a High-angle annular dark-field imaging (HAADF)-STEM image of the finished lamella (left) and EDS mapping of the carbon-based matrix (right) (FIG. 2B), and a magnified HAADF-STEM and EDS mapping images of the carbon-based matrix, showing SiNP clumps (FIG. 2C).

FIG. 2D presents a HRTEM image of a carbon-based outer layer of the carbon-based matrix (FIG. 2D), and a histogram showing the inter-planar distances calculated by image processing of FIG. 2D (FIG. 2E), demonstrating the continuous porous nature of the graphene matrix.

FIG. 2F presents an HAADF-STEM and EDS mapping image of the carbon-based matrix presented in FIG. 2B.

FIG. 2G presents a Selected Area Electron Diffraction (SAED) image of a cluster of silicon nanoparticles within the carbon (LIG) matrix, matching (111), (220), (311) inter-planar distances of crystalline elemental silicon, confirming the retention of the crystalline structure post-lasing.

FIGS. 3A-D present Raman spectrum (FIG. 3A), XPS survey (FIG. 3B), C 1s deconvolution (FIG. 3C), and Si 2p deconvolution (FIG. 3D) of an exemplary LIG/SiNP composite according to some embodiments of the present invention.

FIG. 4A is a schematic presentation of an exemplary procedure for the preparation of an electrode according to some of the present embodiments from a slurry of AZ® 1518 (also referred to herein as “photoresist”) as an exemplary carbonaceous material (also referred to herein as “carbon precursor”) according to some of the present embodiments, and silicon as an electrochemically active material according to some of the present embodiments.

FIG. 4B presents the components of an exemplary CR2032 coin cell battery with which a composite material of some of the present embodiments, deposited on a current collector, is assembled.

FIG. 5A presents C plots showing cycle life of an electrochemical system (half-cell configuration) comprising an exemplary LIG/SiNP electrode according to some of the present embodiments, cycled at 4C between 0.05 and 1 V.

FIG. 5B presents a cyclic voltammetry (CV) curve of an electrochemical system (half-cell configuration) comprising an exemplary LIG/SiNP electrode according to some of the present embodiments, and lithium metal.

FIG. 5C presents comparative plots showing voltage profiles of the electrochemical system (half-cell configuration) described in the context of FIG. 5A.

FIG. 5D presents data showing C-rate performance of a LIG/SiNP-containing electrochemical system according to some of the present embodiments (half-cell configuration), performed by increasing the charging/discharging rates incrementally every 8 cycles, between 0.2 A/g and 10 A/g (C/3 and 16C, respectively), as indicated.

FIG. 5E presents comparative plots showing areal capacity of exemplary multilayered configurations of a LIG/SiNP-containing electrochemical systems according to some of the present embodiments (half-cell configuration; 3-layers and 12 layers, as indicated).

FIG. 5F presents plots showing cycle life of a LIG/SiNP-containing system (half-cell configuration) where a phenol formaldehyde resin was used as a carbon source (carbonaceous material) according to some of the present embodiments.

FIG. 5G presents a plot showing charging profile of the second cycle of a LIG/SiNP-containing electrochemical system according to some of the present embodiments (half-cell configuration), constituting of 36 deposited layers, exhibiting remarkable areal reversible capacity of 5.1 mAh/cm².

FIG. 6A is a plot showing galvanostatic cycling of a 2-layer chitosan-based SiNP composite cycled in a half cell configuration at 300 mA/g over 100 cycles.

FIGS. 6B-C present Raman spectrum of a chitosan-based carbon-silicon composite post-lasing, indicating the formation of a graphene-like structure (FIG. 6B) and HRSEM image of the surface of the porous anode post-lasing (FIG. 6C).

FIG. 7 is a bar graph showing the resulting cycle life, gravimetric capacity, areal capacity and Si content % of an electrochemical system containing an exemplary carbon/silicon composite electrode according to some embodiments of the present invention in comparison with previously described carbon/silicon composite electrodes prepared by different methodologies.

FIGS. 8A-C present HAADF-STEM and EDS mapping images of a lamella prepared from the exemplary anodes (prepared from AZ®1518 as an exemplary carbonaceous material), after cycling it for a prolonged duration, showing an HAADF-STEM image of a cluster of SiNP encased in the carbonaceous matrix (FIG. 8A) and the corresponding EDS mappings of the same area with the presence of oxygen, fluoride and silicon (FIG. 8B) or carbon (FIG. 8C), indicating the encapsulation of the silicon in the carbonaceous graphene network, as well as oxygen and fluorine, which constitute the SEI layer formed during cycling.

FIGS. 8D-G are XPS analyses of the post-cycled exemplary anodes, showing HR spectrums of carbon (FIG. 8D), silicon (FIG. 8E), fluorine (FIG. 8F), and phosphorus (FIG. 8G).

FIGS. 9A-C presents schematic representations of additive manufacturing processes (FIGS. 9A and 9C) and system (FIGS. 9A and 9B) according to some embodiments of the present invention, for preparing an electrochemically active component according to some embodiments of the present invention, by layerwise depositing a mixture comprising a carbonaceous material and an electrochemically active material according to some embodiments of the present invention, and exposing the deposited layer of the mixture to laser irradiation.

FIG. 10 depicts an exemplary electrochemical system (alkali metal ion battery) according to some embodiments of the invention, comprising an electrode according to some embodiments of the invention.

### DESCRIPTION OF SPECIFIC EMBODIMENTS OF THE INVENTION

The present invention, in some embodiments thereof, relates to material science, and more particularly, but not exclusively, to graphene-silicon composite materials usable, for example, as electrodes, to methods of preparing same, and to uses thereof.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Graphene is typically characterized by mechanical stability, electrical conductivity, and ion transport properties, which make it useful in battery applications. In order to improve performance in electrochemical applications, electrochemically active agents or materials that offer higher theoretical specific capacity are conceived. Silicon, for example, features higher specific capacity than carbon and is both abundant and inexpensive, making it an attractive anode material. However, its severe volume changes during cycling (lithiation and delithiation) lead to issues like material pulverization, low coulombic efficiency, and unstable SEI formation, hindering its commercial use. Graphene-silicon composites are an alternative to conventional graphite anodes, as they offer a higher gravimetric capacity and enhanced rate capability in comparison with graphene-based anodes. However, current methods for the synthesis of graphene-silicon composites are energy-intensive, complex, and expensive, hindering their widespread application in commercial battery production.

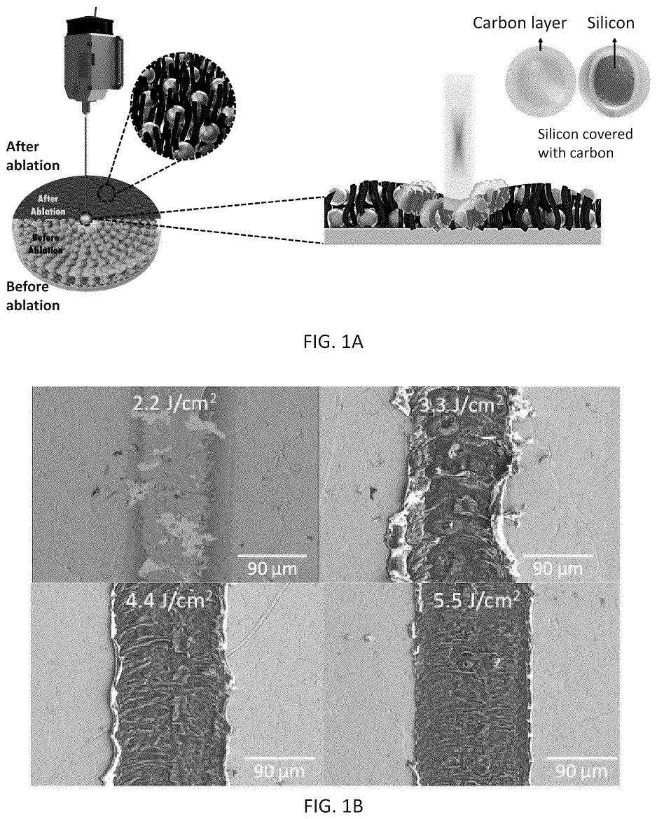

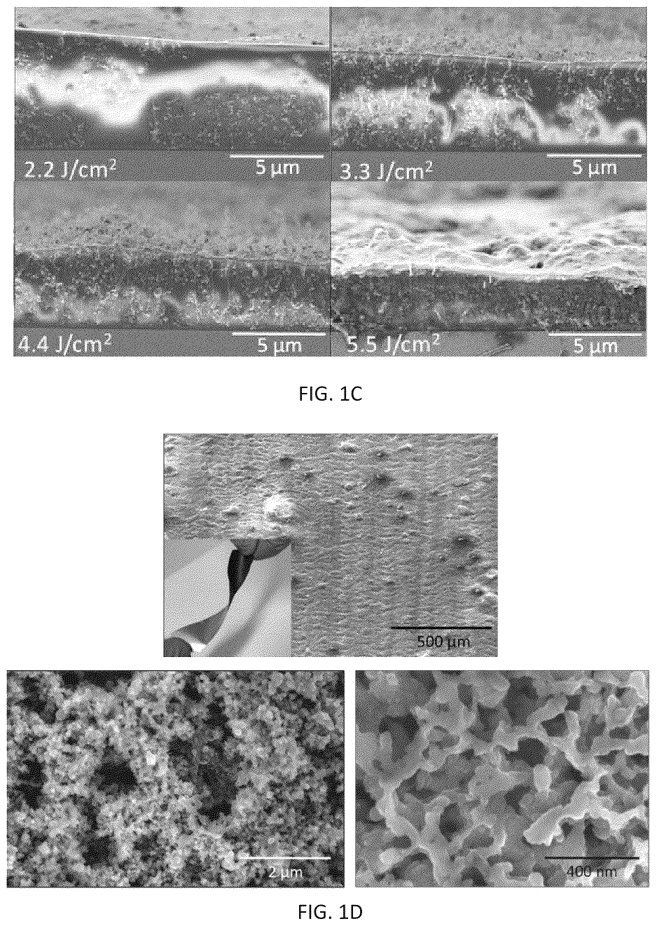

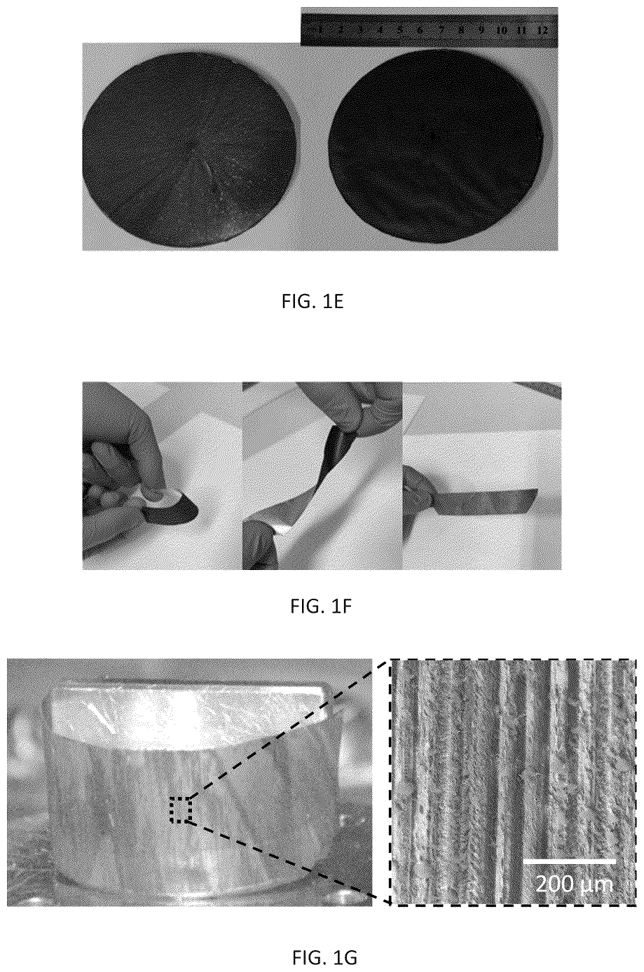

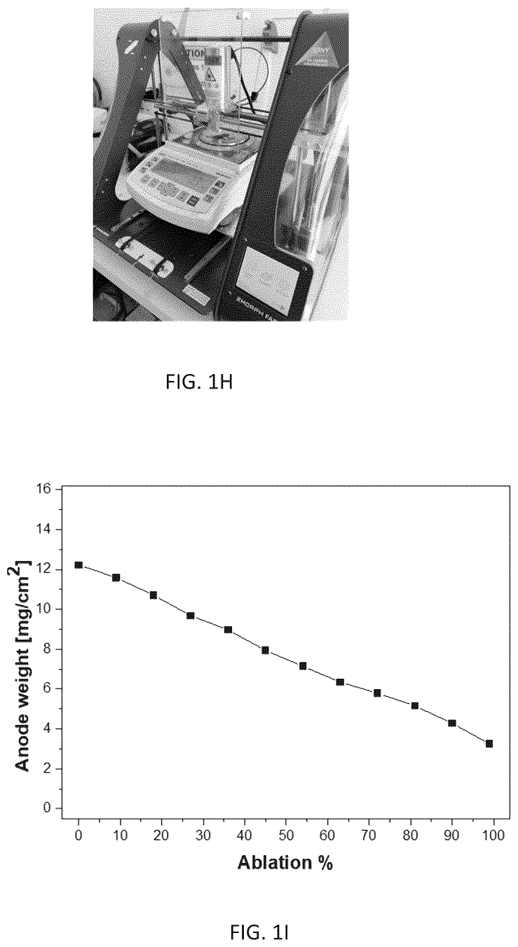

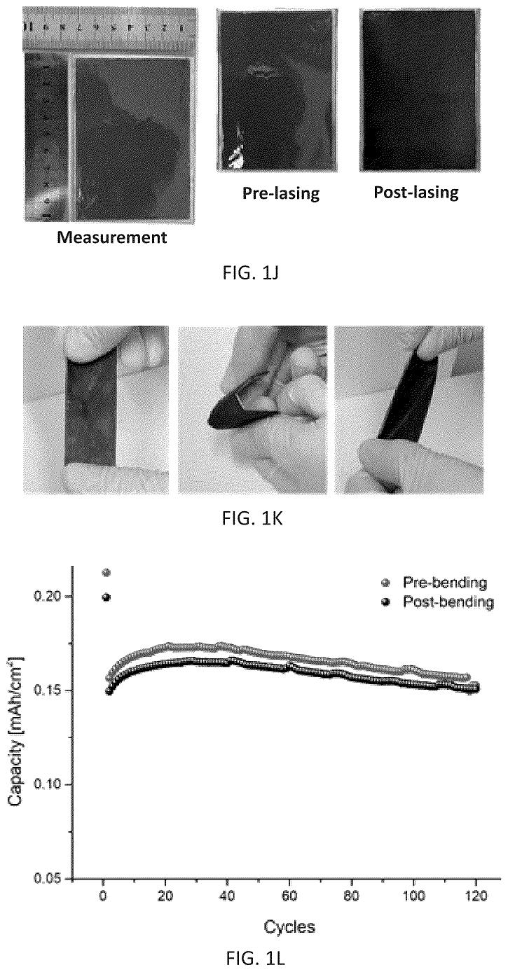

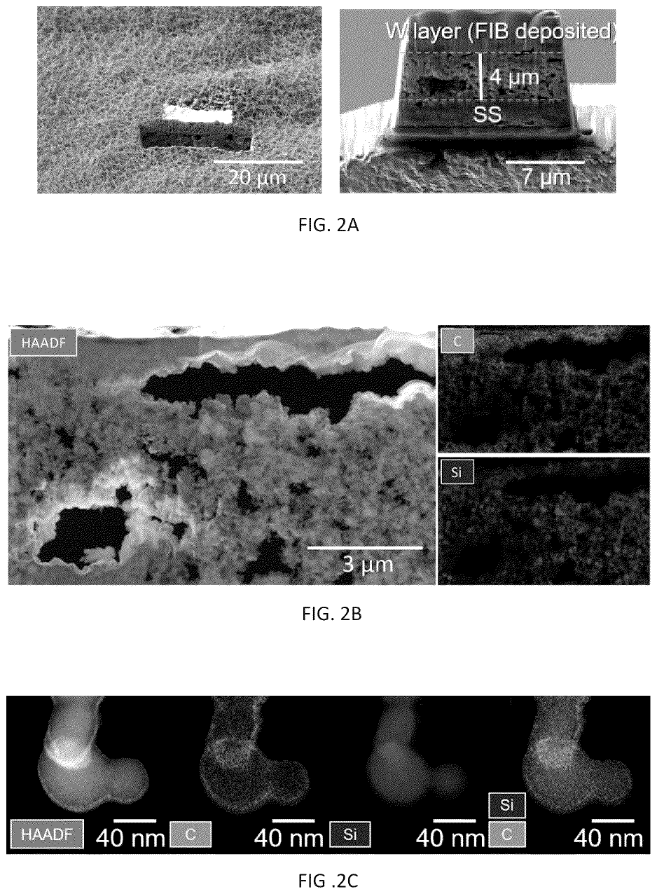

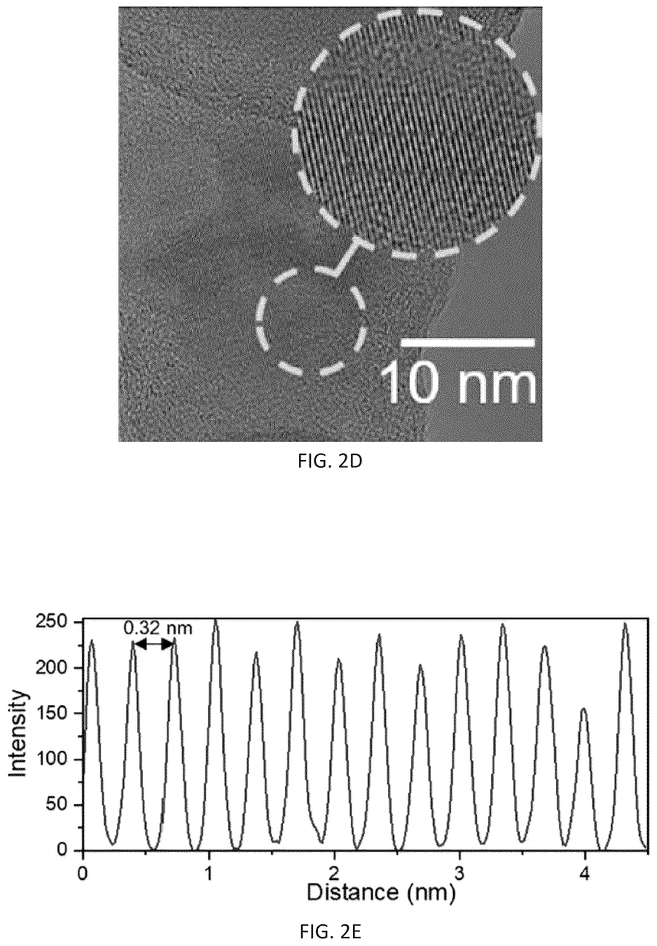

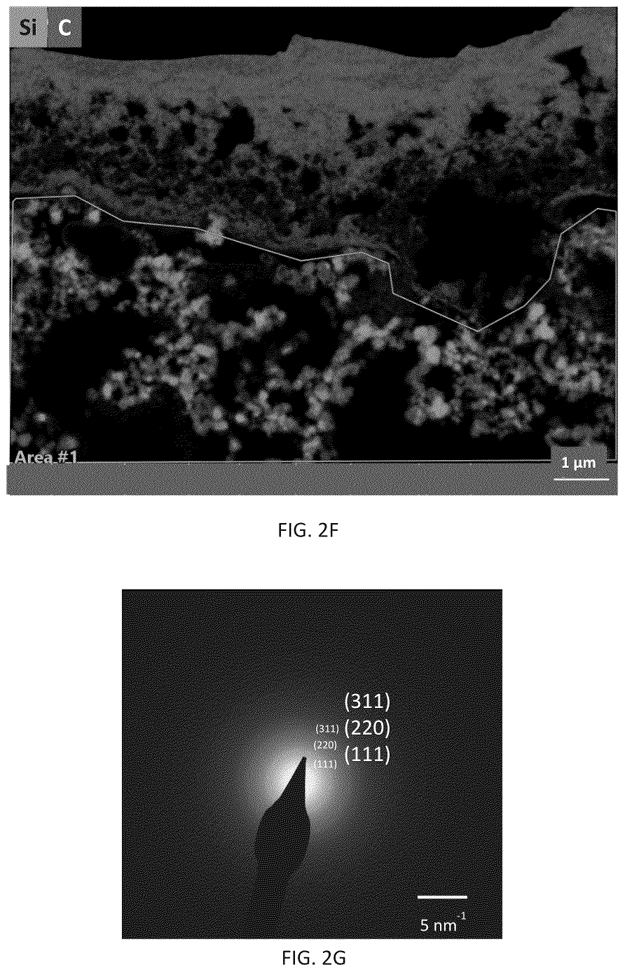

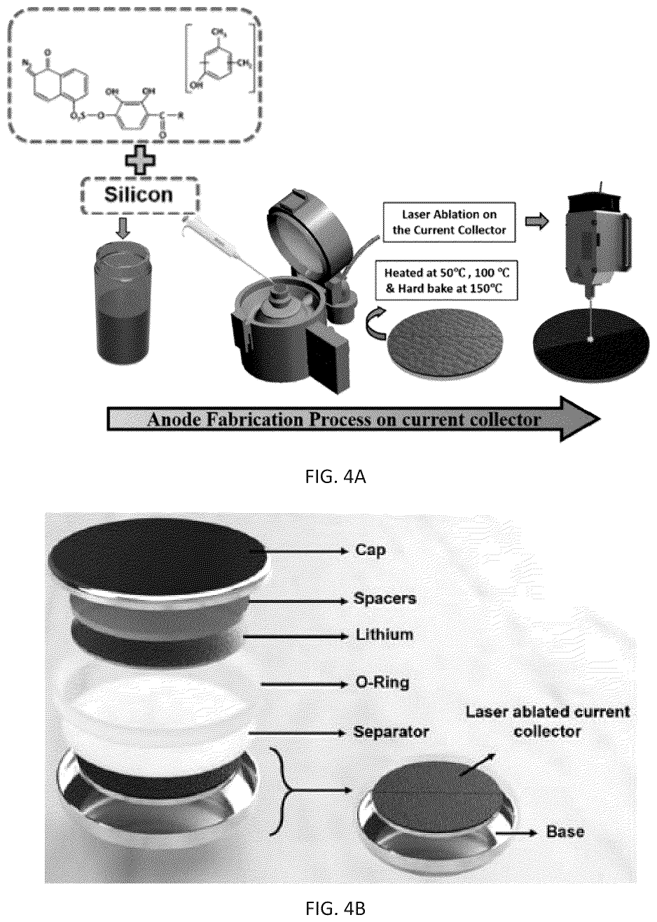

The present inventors have conceived and successfully practiced laser irradiation to transform an additive-free mixture of a carbonaceous material and an electrochemically active agent such as silicon into a 3D porous composite structure in which the electrochemically active agent is embedded within a graphene matrix in a simple, versatile, and low-power technique. See, for example, FIG. 1A. The present inventors have used silicon particles as an exemplary electrochemically active agent or material, have characterized the structural and chemical features of the formed laser-induced 3D porous graphene/silicon composite structure (see, for example, FIGS. 1D, 2A-G), have demonstrated the effect of the process parameters on the formed composite structure and have shown that the formed structure can feature high silicon content (higher than 45% or higher than 65% atomic or weight percentage, respectively) (see, for example, FIG. 2F). The present inventors have integrated the 3D porous composite structure as an electrode in a lithium-based electrochemical cell (e.g., battery), and have shown that such a cell demonstrates exceptional cyclic stability (e.g., over 4500 cycles), ultra-fast charging rates (e.g., higher than 4C), high areal capacity capabilities (e.g., higher than 2.2 mAh/cm²), excellent gravimetric capacity (e.g., higher than 2400 mAh/g), and phenomenal coulombic efficiency (e.g., higher than 99.99%). See, for example, FIGS. 4A-7. The protective function of graphene encapsulation effectively prevents direct contact between silicon and the electrolyte, altering the interfacial characteristics of the composite and rendering it more robust under cycling conditions.

Overall the present inventors have shown that a carbonaceous material can be transformed successfully to laser-induced graphene (LIG) also in the presence of electrochemically active materials such as silicon nanoparticles, and that the obtained 3D porous matrix exhibits improved performance as a component in electrochemical systems such as lithium ion batteries.

The newly devised methodology is scalable and highly-optimizable and hence can be efficiently utilized in the production of assembly-free 3D-printed or 4D-printed graphene composites for high-performance next-generation lithium-ion batteries. The 4D-printing process, which integrates 3D-printing with controlled environmental conditions inducing tunable structural changes, can offer the ability to print entire batteries in a single step, drastically reducing production time and cost, while enhancing design versatility for various applications.

Embodiments of the present invention relate to a newly designed methodology of preparing 3D porous composite structures comprising a porous graphene matrix having an electrochemically active material embedded/entrapped/dispersed therein, to a 3D porous composite structure that comprises a laser-induced graphene matrix having an electrochemically active material embedded/entrapped/dispersed therein, to electrochemical systems such as electrochemical cells and batteries integrating the 3D porous structures, and to methods of making such systems.

Herein throughout, the terms “composite” and “composite structure” are used interchangeably.

According to some of the present embodiments, the 3D porous structure is or forms a part of an electrochemically active component.

Herein the phrase “electrochemically active component” describes a component that can be integrated in an electrochemical system such as an electrochemical half-cell, cell or battery, as an active component that participates in the electrochemical reaction that occurs when the system operates. An electrochemically active component can be an electrode (e.g., an anode or a cathode), a portion of an electrode, or an electrode that is in electric communication with a current collector, for example, is deposited on a current collector.

According to some of any of the embodiments described herein, the electrochemically active component is such that can be integrated in an alkali ion battery such as a lithium ion battery (also abbreviated herein as LIB or referred to interchangeably as lithium battery), as described herein.

Herein, the phrase “alkali metal” encompasses lithium, sodium, potassium, rubidium and cesium and combinations thereof, and encompasses alkali metal atoms (e.g., metallic forms of alkali metals) and alkali metal cations. According to some embodiments, the alkali metal is lithium.

According to an aspect of some embodiments of the present invention there is provided a method of preparing an electrochemically active component as described herein. According to some embodiments, the electrochemically active component is suitable for being integrated in an alkali metal-based electrochemical system such as an alkali metal ion battery.

According to the present embodiments, the method is generally effected by exposing a mixture of a carbonaceous material and an electrochemically active material to laser irradiation, to thereby form a 3D porous structure that comprises a 3D porous graphene matrix having the electrochemically active material dispersed and/or entrapped and/or embedded therewithin.

As used herein and in the art (see, e.g., Scardini, 2021, supra), the term “graphene” describes a single layer of carbon atoms arranged in a two-dimensional honeycomb lattice. As graphene is characterized by favorable electrical conductivity, mechanical strength, and thermal properties, it is useful, e.g., in enhancing the performance of anodes in, e.g., lithium-ion or any other alkali metal ion batteries. When using laser irradiation for its preparation, graphene is typically obtained via one of two ways: by reducing graphene oxide (GO) deposited onto a surface, resulting in what is commonly referred to as “laser-reduced graphene” (LRG), or by transforming carbonaceous materials (as those are described herein), which are non-graphitic, into graphene (also referred to as “laser-induced graphene”, or by its abbreviation, LIG).

As used herein, the phrase “non-graphitic materials” describes carbonaceous materials that do not possess the layered, hexagonal 3D lattice structure characteristic of graphite.

As the formation of the 3D porous graphene matrix as described herein in any of the respective embodiments is induced by laser irradiation as described herein, in some of any of the embodiments described herein, the 3D porous graphene matrix comprises or consists of laser-induced graphene (LIG).

Herein throughout, the phrases “3D porous graphene matrix”, “graphene matrix”, “carbon-based matrix”, “LIG matrix”, “carbonaceous matrix”, “matrix”, “carbon network”, “highly porous network of interconnected LIG-domains”, and “3D porous conductive graphene network”, are used interchangeably, and all describe a network of graphene carbon-based structure having a three-dimensional architecture.

According to some of any of the embodiments described herein, the laser-induced graphene is obtained by exposing a mixture comprising the carbonaceous material as described herein in any of the respective embodiments and particles of the electrochemically active material as described herein in any of the respective embodiments to a laser irradiation as described herein in any of the respective embodiments.

According to some of any of the embodiments described herein, the method is such that the formed 3D porous graphene matrix has a form of a continuous porous matrix or network, in which the electrochemically active material is embedded and/or dispersed and/or entrapped, via physical interactions or via non-covalent chemical interactions. By the term “continuous” it is meant that the 3D porous graphene matrix is not fragmented or interrupted. Continuity of a matrix can be examined, e.g., via HRTEM analysis, as exemplified, e.g., in FIG. 2D.

Herein, the phrases “electrochemically active material”, “electrochemically active agent”, “active material” and “active agent” are used interchangeably and all describe a material (agent) that can participate in an electrochemical reaction, such that when it is present in an electrochemical system such as a battery as described herein, it participates in the electrochemical reaction that occurs when the system (e.g., battery) operates.

According to some of any of the embodiments described herein, the electrochemically active material is such that can participate in an electrochemical reaction that occurs when an alkali metal-based electrochemical system such as a battery as described herein operates. According to some of these embodiments, the electrochemically active material is such that is capable of reversibly releasing an alkali metal ion, for example, a lithium ion.

According to some of these embodiments, the electrochemically active material is such that can form a part of an anode in an alkali metal battery.

The phrase “reversibly releasing” means that the material is capable of absorbing and/or interacting with the alkali metal (e.g., an alkali metal ion), e.g., by forming a chemical complex (e.g., an alloy) with the alkali metal, during charging, and is capable of releasing the alkali metal (e.g., alkali metal ion) during discharging.

When the alkali metal is lithium, the electrochemically active material is capable of reversibly undergoing lithiation during charging and delithiation during discharging.

According to some embodiments of the present invention, the electrochemically active material features a theoretical capacity which is higher than that of graphene, for example, is higher by at least 50%, or by at least 100%, or by at least 200%, or more, for example, up to 100,000%, than the theoretical capacity of graphene with respect to lithium.

According to some of any of the embodiments described herein, the electrochemically active material is in a form of a plurality of particles. The particles can be, for example, microparticles and/or nanoparticles.

According to some of any of the embodiments described herein, the electrochemically active material is in a form of a plurality of nanoparticles.

According to some of any of the embodiments described herein, the particles have an average diameter in a range of from 1 to 800, or from 1 to 600, or from 1 to 500, or from 1 to 300, nm, including any intermediate values and subranges therebetween. According to some of any of the embodiments described herein, the particles have an average diameter in a range of from 1 to 300, or from 10 to 300, or from 25 to 300, or from 50 to 300, or from 75 to 300, or from 1 to 200, or from 10 to 200, or from 25 to 200, or preferably from 50 to 200, or from 75 to 200, or from 10 to 250, or from or from 25 to 250, or from 50 to 250, or from 75 to 250, or from 1 to 175, or from 10 to 175, or from 25 to 175, or from 50 to 175, or from 75 to 175, or from 1 to 150, or from 10 to 150, or from 25 to 150, or from 50 to 150, or from 75 to 150, or from 1 to 125, or from 10 to 125, or from 25 to 125, or from 50 to 125, or from 75 to 125, including any intermediate values and subranges therebetween, or of up to 200 nm. In exemplary embodiments, the particles have an average diameter of about 100 nm.

According to some of any of the embodiments described herein, the electrochemically active material is or comprises silicon.

According to some of any of the embodiments described herein, the electrochemically active material is silicon.

According to some of any of the embodiments described herein, electrochemically active material is or comprises a plurality of silicon particles, for example, a plurality of silicon nanoparticles.

According to some of any of the embodiments described herein, the electrochemically active material is or comprises silicon, and the particles are or comprise silicon nanoparticles.

In some of any of the embodiments described herein, the electrochemically active material dispersed and/or embedded and/or entrapped therewithin the graphene matrix is crystalline.

As used herein, the term “crystalline” describes a compound that has a well-defined, ordered atomic structure, characterized by a repeating pattern in three dimensions. This ordered structure gives rise to specific crystallographic orientations of planes, which are described by Miller indices. These indices represent particular planes within the crystal lattice, each with a unique arrangement of atoms. The degree to which these ordered planes are present in a material is referred to as its crystallinity, which can be determined through techniques like X-ray diffraction (XRD) or Selected Area Electron Diffraction (SAED).

In some of any of the embodiments described herein, a crystallographic orientation of plane of the electrochemically active material dispersed and/or embedded and/or entrapped therewithin the graphene matrix is similar to the a crystallographic orientation of plane of the electrochemically active material prior to the exposure of a mixture comprising it to laser irradiation (i.e., it retains its crystallographic orientations of planes upon exposure to laser irradiation). Crystallographic orientations of planes can be determined, e.g., via Selected Area Electron Diffraction (SAED) analysis, as exemplified, e.g., in FIG. 2G. In some of any of the embodiments described herein, a crystallographic orientations of planes within the electrochemically active material dispersed and/or embedded and/or entrapped therewithin the graphene matrix is (111), (220), (311).

According to some of any of the embodiments described herein, an amount of the electrochemically active material in the mixture is at least 1%, or at least 2%, or at least 3%, or at least 4%, or at least 5%, and up to 30%, by weight of a total weight of the mixture, including any intermediate values and subranges therebetween.

According to some of any of the embodiments described herein, an amount of the electrochemically active material ranges from to 50, or from 1 to 40, or from 1 to 30, or from 1 to 20, or from 1 to 10, % by weight, a total weight of the mixture, including any intermediate values and subranges therebetween.

According to some of any of the embodiments described herein, the carbonaceous material is an organic material that inherently comprises carbon atoms, and which is capable of forming graphene when exposed to laser irradiation.

Herein throughout, the phrases “carbonaceous material”, “carbon source” and “carbon precursor” are used interchangeably, and describe an organic material (that inherently comprises carbon atoms), preferably a carbon-enriched organic material, which is capable of transforming to graphene when exposed to suitable conditions.

According to some of any of the embodiments described herein, the carbonaceous material is selected capable of transforming to graphene following the exposure to the laser irradiation. Such materials are typically carbon-rich materials and include, for example, polymerizable and/or crosslinkable materials, including polymeric and non-polymeric synthetic materials, and natural substances.

Exemplary carbonaceous materials usable in the context of these embodiments include, but are not limited to, polyimides (PI), silicon polyethers such a PDMS, polyetherimides (PEI), polycarbonates (PC), poly(ether ketones) (PEEK), poly(alkylenes glycols), sulfonate poly(ether ketones) (SPEEK), poly(methyl methacrylates) (PMMA), polyacrylonitriles (PAN)), polypyrroles, aromatic (e.g., phenolic) resins, cellulose, cellulose derivatives (e.g., carboxymethyl cellulose (CMC)), hemicelluloses, lignin, chitosan, sucrose, wheat starch, and any combination thereof.

A carbonaceous material can be derived from a natural source or be a natural biomass, for example, wood and wheat, or from a carbon-enriched food substance such as bread and potatoes. A carbonaceous material can comprise saccharides or polysaccharides (e.g., sucrose, chitosan) or can be a biomass enriched with saccharides or polysaccharides.

A carbonaceous material can alternatively be or comprise carbon-enriched polymeric or non-polymeric synthetic material, such as, for example, aromatic resins, for example, mixtures usable as photoresists.

An exemplary carbonaceous material is or comprises an aromatic resin such as a phenolic resin, which a synthetic polymer formed by a reaction of phenol (an aromatic compound) and aldehyde (for example, formaldehyde). A phenolic resin is typically partially polymerized (e.g., it comprises oligomeric or short polymeric chains) and undergoes polymerization and/or cross-linking when subjected to suitable conditions, either alone or when mixed with a cross-linking agent.

An exemplary carbonaceous material that comprises and a phenolic resin made of phenol and aldehyde is shown in FIG. 4A (as a combination with 1-methoxy-2-propanol acetate).

Any carbonaceous material or a mixture of carbonaceous materials that is/are capable of transforming to graphene when subjected to laser irradiation is contemplated. According to some of any of the embodiments described herein, the carbonaceous material is other than graphite or graphite oxide.

According to some of any of the embodiments described herein, the carbonaceous material is devoid of graphite.

As used herein throughout, the phrase “devoid of” describes an amount of a compound or a material (e.g., in a mixture or a structure as described herein) that is lower than 5%, or lower than 1%, or lower than 0.5%, or lower than 0.1%, or lower than 0.05% or lower than 0.01%, or lower than 0.001%, or is null, meaning the compound is substantially absent.

Without being bound to any particular theory, it is assumed that carbonaceous materials according to some embodiments described herein are transformed into a carbon-based matrix by the temperature and pressure conditions generated by laser irradiation, while excess material inherent to the precursor is released as gaseous by-products, thus resulting in a 3D porous structure.

According to some of any of the embodiments described herein, the method is effected by depositing a mixture of a carbonaceous material as described herein in any of the respective embodiments and an electrochemically active material as described herein in any of the respective embodiments on a substrate as described herein in any of the respective embodiments, and exposing the substrate the laser irradiation (e.g., a laser irradiation that transforms the carbonaceous material to a 3D porous graphene (e.g., continuous) matrix as described herein).

According to some of any of the embodiments described herein, the method is effected by depositing at least one layer of a mixture that comprises a carbonaceous material and an electrochemically active material as described herein in any of the respective embodiments onto a substrate such as a conductive substrate as described herein in any of the respective embodiments, to thereby obtain the conductive substrate having the at least one layer deposited on at least a portion of a surface thereof, as described herein in any of the respective embodiments; and exposing the conductive substrate having the at least one layer deposited thereon to laser irradiation, as described herein in any of the respective embodiments. The method is such that forms a 3D porous structure deposited onto the at least a portion of the surface of the (e.g., conductive) substrate, as described herein in any of the respective embodiments.

In some of any of the embodiments described herein, the mixture is devoid of additives (e.g., at least one of catalysts, conductive additives, binders (such as organic polymer binders), polymer additives, dopants and functional groups, and metal oxides). In some embodiments, the 3D porous structure is devoid of additives (e.g., as those are defined herein) and/or decomposition products of the additives.

Non-limiting examples for binders include polyvinylidene fluoride (PVDF), carboxymethyl cellulose (CMC), and styrene-butadiene rubber (SBR).

Non-limiting examples for conductive additives include carbon black, carbon nanotubes (CNTs), and Super P®.

Non-limiting examples for polymer additives include polyethylene oxide (PEO) and polyacrylic acid (PAA).

Non-limiting examples for dopants and functional groups include nitrogen (N)-doping and oxygen functional groups.

Non-limiting examples for metal oxides include titanium oxide (TiO₂), manganese dioxide (MnO₂) or nickel oxide (NiO).

According to some of any of the embodiments described herein, the mixture that comprises the carbonaceous material and the electrochemically active material features a consistency of a liquid or a semi-solid (e.g., gel) composition. According to some of any of the embodiments described herein, the carbonaceous material is a liquid or semi-solid material. When the electrochemically active material is in a form of particles, the mixture can be in a form of a slurry or a dispersion of the particles in the liquid or semi-solid carbonaceous material.

According to some of any of the embodiments described herein, the carbonaceous material is in a form of a liquid or a semi-solid (e.g., a gel) at room temperature.

According to some of these embodiments, when the electrochemically active material is in a form of a plurality of particles, the mixture is in a form of a slurry that comprises the particles dispersed in the carbonaceous material.

According to some of any of the embodiments described herein, the carbonaceous material is in a form other than a powder at room temperature.

According to some of any of the embodiments described herein, the carbonaceous material is in a non-particulate or non-granulated form at room temperature.

According to some of any of the embodiments described herein, the mixture is devoid of graphite or is devoid of a graphitic substance or is devoid of graphite powder.

According to some of any of the embodiments described herein, the mixture consists essentially from a carbonaceous material and an electrochemically active material as described herein. One or more carbonaceous materials and one or more electrochemically active materials can be included in the mixture.

According to some of any of the embodiments described herein, the mixture further comprises a flame retardant (e.g., boric acid).

In some of any of the embodiments described herein, prior to depositing the mixture on a substrate, the mixture is subjected to homogenization (the mixture is homogenized). Non-limiting examples for homogenizing a mixture include mechanical stirring, ultra-sonication, high-shear mixing, and ball milling.

It is to be understood that a liquid or a semi-solid consistency of the mixture may facilitate depositing the mixture onto the conductive substrate, while subjecting the mixture to homogenization assures that the deposition is consistent and uniform.

According to some of any of the embodiments described herein, the mixture is deposited in the substrate so as to form a layer of the mixture onto at least portion of a surface of the substrate. Depositing the mixture onto the substrate can be effected by any technique suitable for depositing liquid or semi-solid (e.g., slurry) mixtures include spin coating, dip coating, spray coating, doctor blading, electrophoretic deposition, drop casting, bar coating, slot-die coating, Langmuir-Blodgett deposition, inkjet printing, electrospinning, and smearing and/or applying by hand.

In exemplary embodiments, depositing is effected by spin coating.

As used herein and in the art, the phrase “spin coating” describes a method in which a mixture is deposited onto the center of a substrate, which is then rapidly spun at high speeds. The centrifugal force spreads the mixture evenly across the surface, forming a thin film as the solvent evaporates.

As used herein and in the art, the phrase “dip coating” describes a method in which a substrate is immersed in a mixture and then withdrawn at a controlled speed, allowing a thin film to form on the surface as the solvent evaporates.

As used herein and in the art, the phrase “spray coating” describes a method where a mixture is sprayed onto a surface using a spray nozzle, often followed by drying or curing to form a uniform coating.

As used herein and in the art, the phrase “doctor blading” (also known as “tape casting”) describes a method in which a mixture is spread over a surface using a blade or flat edge, creating a uniform thin film as the blade moves across the substrate.

As used herein and in the art, the phrase “electrophoretic deposition” (EPD) describes a method where charged particles in a mixture are deposited onto a conductive substrate by applying an electric field, causing the particles to migrate and form a coating on the surface.

As used herein and in the art, the phrase “drop casting” describes a method in which a mixture is dropped onto a surface and allowed to spread and dry naturally, forming a film as the solvent evaporates.

As used herein and in the art, the phrase “bar coating” (also known as “wire-wound rod coating”) describes a method where a wire-wound rod (bar) is used to spread a uniform layer of a mixture across a surface as it is drawn over the substrate.

As used herein and in the art, the phrase “slot-die coating” describes a method in which a mixture is extruded through a narrow slot and deposited directly onto a moving substrate, providing precise control over the thickness of the coating.

As used herein and in the art, the phrase “Langmuir-Blodgett deposition” describes a method in which a monolayer or multilayer film is transferred from the surface of a liquid to a substrate by dipping the substrate through the liquid-air interface.

As used herein and in the art, the phrase “inkjet printing” describes a method in which a mixture is precisely deposited onto a surface using inkjet printing technology, allowing for patterning or selective area coverage.

As used herein and in the art, the phrase “electrospinning” describes a method in which a mixture is ejected from a needle under a high-voltage electric field, forming fibers that are collected on a substrate as a non-woven mat.

As used herein and in the art, the phrase “smearing and/or applying by hand” describes a manual method in which a mixture is spread over a surface by physically smearing or applying it by hand, which is useful, e.g., to ensure coverage on irregular surfaces or when precision tools are not required.

According to some of any of the embodiments described herein, the depositing is effected on a portion of the substrate, preferably of a surface of the substrate, for example, on at least 10%, or at least 20%, or at least 30%, or at least 40%, or at least 50%, or at least 60, or at least 70, or at least 80, or at least 90, or substantially all (100%) of the surface of the substrate.

According to some of any of the embodiments described herein, the depositing is of one layer of the mixture. According to some of any of the embodiments described herein, the depositing is of two or more layers of the mixture.

According to some of any of the embodiments described herein, a number of layers and a thickness of each layer are selected such that a total thickness of the layer or two or more layers ranges from 1 to 1000, or from 10 to 1000, or from 100 to 1000, or from 500 to 1000, or from 1 to 500, or from 10 to 500, or from 100 to 500, or from 1 to 200, or from 1 to 150, or from 1 to 100, or from 1 to 50, or from 1 to 10, or from 50 to 200, or from 50 to 150, or from 100 to 200, or from 150 to 200, or from 1 to 100, or from 10 to 100, or from 50 to 100, micrometers, including any intermediate values and subranges therebetween.

In some of any of the embodiments described herein, a thickness of one layer ranges from 1 to 20, or from 1 to 15, or from 1 to 10, or 1 to 8, or from 1 to 5, or from 2 to 10, or from 2 to 8, or from 2 to 5, or from 3 to 10, or from 3 to 8, or from 3 to 5, or is about 4, micrometers, including any intermediate values and subranges therebetween.

It is to be understood that a number and/or thickness of the at least one layer of the mixture can be manipulated as desired, per the selected carbonaceous material and/or electrochemically active material as those are described herein, per selected deposition technique as described herein, per the parameters of the laser irradiation, and/or per selected application.

In some of any of the embodiments described herein, a thickness of a mixture deposited onto the conductive substrate prior to exposing the conductive substrate to laser irradiation is higher by at least 2, or at least 5, or at least 10, or at least 15, or at least 20, % of the thickness of the 3D porous structure deposited onto the at least a portion of the surface of the conductive substrate, including any intermediate values and subranges there between.

According to some of any of the embodiments described herein, once the mixture is deposited, the method is further effected by heating the substrate having the mixture deposited thereon.

According to some of any of the embodiments described herein, heating the substrate having the at least one layer deposited thereon is at a temperature of from 40, and up to 200, or up to 150, or up to 120, or up to 100, ° C., for example, is in a range of from 40 to 200, or from 40 to 150, or from 40 to 120, or from 40 to 100, or from 50 to 150, or from 50 to 120, or from 50 to 100, ° C., including any intermediate values and subranges therebetween. Such heating is also referred to herein as “soft baking”.

According to some of any of the embodiments described herein, heating is for a time period of at least 10 seconds, or at least 30 seconds, or at least 45 seconds, or at least or at least 1 minute, for example, is in a range of from 10 seconds to 1 hour, or from 10 second to 30 minutes, or from 10 seconds to 10 minutes, or from 10 seconds to 1 minute, or from 10 seconds to 30 seconds, including any intermediate values and subranges therebetween.

In some of any of the embodiments described herein, heating is at a temperature of up to 200, or up to 150, or up to 120, or up to 100, ° C., including any intermediate values and subranges therebetween; and for a time period of at least 10 seconds, or at least 30 seconds, or at least 45 seconds, or at least 1 minute, and up to 10 hours, including any intermediate values and subranges therebetween. According to some of any of the embodiments described herein, heating is performed subsequent to depositing each of the one or more layers.

In some embodiments, heating is performed at least twice, subsequent to depositing each of the two or more layers (i.e., the method comprises depositing a first layer of the mixture; performing a first heating of the substrate having the first layer deposited thereon; depositing a second layer of the mixture; performing a second heating of the substrate having the second layer deposited thereon; and so forth). In some such embodiments, each heating (e.g., the first heating and the second heating, and following heatings) is performed at the same temperature and/or time period. Alternatively, each heating (after depositing each layer) is performed at a different temperature and/or different time period. In some such embodiments, the second heating is a temperature lower than the temperature of the first heating. In some such embodiments, the second heating is at a temperature higher than the first heating. In some such embodiments, when three or more heatings are performed over three or more deposited layers, each heating is at a temperature lower that the preceding heating. Alternatively, each heating is at a temperature higher than a preceding heating. In exemplary embodiments, the first heating at a temperature of up to 100, or up to 75, or up to 50, or up to 40, ° C., including any intermediate values and subranges therebetween; and the second heating is at a higher temperature; and following heatings, if further layers are deposited are at the same or higher temperatures than a preceding heating. In some such embodiments, the first heating is at a temperature of up to 50° C., and the second heating is at a temperature in a range of from 50 to 200, or from 50 to 150, or from 50 to 120, or from 50 to 100, ° C., including any intermediate values and subranges therebetween.

In alternative embodiments, heating is performed subsequent to depositing two or more layers of the mixture (i.e., the method comprises depositing two or more layers of the mixture, and performing a heating of the substrate after all layers have been deposited.

According to some of any of the embodiments described herein, the substrate can be made of any material that remains inert during the depositing, optional heating and laser irradiation, as described herein. The substrate can be made of organic or inorganic materials, for example, metal, metal alloy, plastic, glass, other polymeric materials, etc.

According to some of any of the embodiments described herein, the substrate is a conductive substrate which comprises one or more conductive materials, for example, one or more conductive or semi-conductor materials such as, for example, conductive or semi-conductive metals. In exemplary embodiments, the conductive substrate comprises one or more of stainless steel, copper, and aluminum. According to some of any of the embodiments described herein, the substrate is a conductive substrate made of materials that can later on be integrated in an electrochemical system.

According to some of any of the embodiments described herein, the conductive substrate is or can form a part of a component of an electrochemical system, such that when the 3D porous structure is formed on at least a portion thereof, the resulting structure can be integrated in an electrochemical system.

According to some embodiments, the conductive substrate is or forms a part of a current collector.

As used herein, the phrase “current collector” describes a conductive component in an electrochemical cell that facilitates the transfer of electric current between the external circuit and the active material within the cell, as described further hereinbelow.

In some of any of the embodiments described herein, once all layers have been deposited, the method proceeds to exposing the deposited mixture to laser irradiation. According to some of any of the embodiments described herein, exposing is subsequent to depositing the two or more layers.

It is to be understood that it does not matter how many layers and how and if some or all of the layers are heated, irradiation is applied to all layers altogether, unless otherwise indicated (e.g., when the electrochemically active component is prepared by additive manufacturing, as described herein in any of the respective embodiments).

As used herein and in the art, the term “lasing” describes the process by which a laser generates coherent light through the amplification of photons in a gain medium via stimulated emission.

As used herein and in the art, the phrase “laser writing” describes the process of using a laser beam to directly inscribe, engrave, or modify a material's surface according to a predefined pattern or design.

As used herein and in the art, the term “rastering” describes a laser processing technique where a laser or other imaging device scans back and forth over a surface in a systematic pattern, usually in parallel lines, to create or modify an image or material. Unlike laser writing, rastering is typically used when the entire area needs to be uniformly covered, rather than following a specific vector path or design outline.

Herein throughout, the term “laser irradiation” and grammatical diversions thereof, encompasses and used interchangeably with lasing, laser writing and laser rastering or simply rastering or irradiation.

According to some of any of the embodiments described herein, the laser irradiation is performed by rastering. In some of any of the embodiments described herein, the rastering is performed in one or more scans (paths) across the surface of the (e.g., conductive) substrate, for example, the rastering can be performed in 2, 3, 4, 5, 6, or even more, scans. The number of scans depends on the desired depth of modification on the conductive substrate. In exemplary embodiments, the rastering is performed in two scans.

According to some of any of the embodiments described herein, the laser irradiation is performed at any wavelength (i.e., from UV to NIR; from 10 nm to 1400 nm, including any intermediate values and subranges therebetween). According to some of any of the embodiments described herein, the laser irradiation is performed within a UV wavelength range (i.e., from 10 nm to 400 nm, including any intermediate values and subranges therebetween). According to some of any of the embodiments described herein, the laser irradiation is performed at NIR wavelength length (i.e., from 700 nm to 1400 nm, including any intermediate values and subranges therebetween). According to some of any of the embodiments described herein, the laser irradiation is performed at visible wavelength length (i.e., from 400 nm to 700 nm, including any intermediate values and subranges therebetween). According to some of any of the embodiments described herein, the laser irradiation is performed at a wavelength in a range of from 400 to 700 nm, or from 400 to 500 nm, including any intermediate values and subranges therebetween. In exemplary embodiments, the laser irradiation is performed at wavelength of about 450 nm.

According to some of any of the embodiments described herein, the laser irradiation is performed at a power level of at least 1.0 W, or at least 2.0 W, or at least 2.5 W, or at least 2.8 W, or at least 4.0 W, or at least 6.0 W, or at least 8.0 W, or at least 10.0 W, or at least 20.0 W, or even higher, e.g., 200 W, including any intermediate values and subranges therebetween. In exemplary embodiments, the laser irradiation is performed at a power level of about 2.8 W.

According to some of any of the embodiments described herein, the laser irradiation is performed for a time period of at least 1 second, or at least 5 seconds, or at least 10 seconds, or at least 30 seconds, or more, and up to 1 hour, for example, from 1 second to 30 second, or from 5 second to 30 seconds, including any intermediate values and subranges therebetween.

According to some of any of the embodiments described herein, the laser irradiation is performed at a fluence in a range of at least 3.5, or at least 4.0, or at least 4.4, and up to 50.0, J/cm², including any intermediate values and subranges therebetween. In exemplary embodiments, the laser irradiation is performed at a fluence of 5.5, J/cm².

Herein, the term “fluence” describes the energy per unit area delivered by a laser beam to a surface. The fluence determines the amount of energy applied to the mixture, which can affect the extent of physical or chemical changes induced by the laser irradiation.

In some of any of the embodiments described herein, exposing comprises irradiating the deposited mixture with a continuous visible laser irradiation (e.g., 450 nm).

In some of any of the embodiments described herein, a spot size diameter of the laser irradiation is in a range of from 5 to 20, or is about 10, μm (micrometers).

In some of any of the embodiments described herein, a speed of the laser irradiation is in a range of from 1 to 40, or is about 20, mm/s.

In some of any of the embodiments described herein, a hatch spacing of the laser irradiation is in a range of from 0.01 to 0.05, or is about 0.1, mm.

In some of any of the embodiments described herein, subsequent to exposing to laser irradiation as described herein, heating the substrate having the 3D porous structure deposited thereon is effected.

According to some of any of the embodiments described herein, heating is at a temperature of at least 100° C., or at least 120° C., or at least 150° C., for example, in a range of from 100° C. to 250° C., or from 100° C. to 200° C., or is about 150° C., including any intermediate values and subranges therebetween. Such heating is also referred to herein as “hard baking”.

According to some of any of the embodiments described herein, the heating (e.g., the hard baking) is for a time period of at least 1 minute, or at least 5 minutes, or at least 10 minutes, or at least 15 minutes, and up to 1 hour, including any intermediate values and subranges therebetween.

The method as described herein in any of the respective embodiments and any combination thereof, provides a 3D porous structure that comprises a 3D porous graphene matrix and an electrochemically active material dispersed and/or entrapped and/or embedded therewithin.

A method as described herein is such that the carbonaceous materials and the electrochemically active material, as those are described herein in any of the respective embodiments, form a 3D porous structure upon exposure to laser irradiation as described herein in any of the respective embodiments.

As used herein, the term “3D porous structure” describes a 3D continuous network, for example, in a form of a film, having a plurality of interconnected pores (holes, voids) therewithin.

According to the present embodiments, the 3D porous structure comprises a 3D graphene matrix, that is the graphene that is formed by laser irradiation (laser-induced graphene; LIG) is in a form of a 3D continuous network, for example, in a form of a film, having a plurality of interconnected pores (holes, voids) therewithin.

According to some of any of the embodiments described herein, the 3D graphene matrix is in a non-particulated form, that is, it is substantially devoid of graphene particles, but is rather is a form of a continuous 3D network (e.g., film).

According to some of any of the embodiments described herein, an overall porosity of the 3D porous structure is of at least 10, or at least 20, or at least 30, or at least 40, or at least 45, and up to 90, or ranges from 10 to 90, or from 10 to 80, or from 10 to 70, or from 10 to 60, or from 10 to 50, or from 10 to 40, or from 10 to 30, or from 10 to 20, or from 20 to 80, or from 20 to 70, or from 20 to 60, or from 20 to 50, or from 30 to 90, or from 40 to 90, or from 50 to 90, or from 60 to 90, or from 70 to 90, or from 30 to 80, or from 40 to 80, or from 30 to 70, or from 40 to 70, or from 30 to 60, or from 40 to 60, or from 30 to 50, or from 40 to 50, %, including any intermediate values and subranges therebetween when analyzing a binary SEM image with a threshold of 127.

Herein, the phrase “binary SEM image” refers to an image in which each pixel is represented by one of two colors, black or white, where black represents the background and white represents the foreground, or vice versa. The image is generated from a scanning electron microscope (SEM) image, and each pixel is converted to black or white based on a specified threshold value ranging from 0 to 255 (e.g., 127), where 0 represents black, 255 represents white, and values in between determine whether the pixel is converted to black or white depending on whether they fall below or above the threshold.

According to some of any of the embodiments described herein, the electrochemically active material (e.g., silicon particles) is present or occupies in at least a portion of the pores within the 3D graphene matrix, such that it is dispersed/embedded/entrapped within the matrix.

According to some of any of the embodiments described herein, a content of the electrochemically active material in the 3D porous structure is at least 10%, or at least 20%, or at least 30%, or at least 40%, or at least 50%, or at least 60%, by weight, of the total weight of the 3D porous structure, including any intermediate values and subranges therebetween.

According to some of any of the embodiments described herein, a content of the electrochemically active material in the 3D porous structure ranges from 10 to 80, or from 20 to 80, or from 30 to 80, or from 40 to 80, or from 40 to 70, or from 50 to 70, or from 60 to 70, or from 50 to 80, or from 60 to 80, or is about 68, % by weight of the total weight of the 3D porous structure, including any intermediate values and subranges therebetween.

According to some of any of the embodiments described herein, a carbon content of the 3D porous structure ranges from 10 to 80, or from 10 to 70, or from 10 to 60, or from 10 to 50, or from 10 to 40, or from 10 to 30, or from 20 to 40, or from 20 to 30, or is about 25, % by weight of the total weight of the 3D porous structure, including any intermediate values and subranges therebetween.

According to some of any of the embodiments described herein, the electrochemically active material is or comprises silicon nanoparticles as described herein, and the content of silicon in the 3D porous structure ranges from 10 to 80, or from 10 to 70, or from 10 to 60, or from 10 to 50, or from 10 to 40, or from 10 to 30, or from 40 to 80, or from 40 to 70, or from 50 to 70, or from 60 to 70, or from 50 to 80, or from 60 to 80, or is about 68, % by weight of the total weight of the 3D porous structure, including any intermediate values and subranges therebetween.

In some of any of the embodiments described herein, the electrochemically active material is or comprises silicon nanoparticles as described herein, and the silicon-to-carbon atomic ratio in the 3D porous structure ranges from 1:10 to 10:1, or from 1:5 to 5:1, or from 1:2 to 2:1, or from 1.5:1 to 1:1.5, or from 1.2:1 to 1:1.2, including any intermediate values and subranges therebetween.

According to some of any of the embodiments described herein, an oxygen content of the 3D porous structure is lower than 20%, or lower than 15%, or lower than 10%, or lower than 8%, or lower than 5%, or lower than 3%, and even lower, e.g., lower than 1%, by weight, of the total weight of the 3D porous structure, including any intermediate values and subranges therebetween.

According to some of any of the embodiments described herein, an oxygen content of the 3D porous structure ranges from 1 to 20, or from 1 to 15, or from 1 to 10, or from 3 to 10, or from 4 to 8, or is about 6, % by weight of the total weight of the 3D porous structure, including any intermediate values and subranges therebetween.

According to some of any of the embodiments described herein, an atomic content of nitrogen in the 3D porous structure is less than 5%, or less than 2%, or less than 1%, or is less than 0.5%, or even less, e.g., 0%, including any intermediate values and subranges therebetween.

In some of any of the embodiments described herein, the low oxygen content of the 3D porous structure is indicative of the low amount of oxidized carbon and/or oxidized silicon species in the 3D porous structure.

According to some of any of the embodiments described herein, the 3D porous graphene matrix is in a form of a continuous porous matrix or network. In some of any of the embodiments described herein, the 3D porous graphene matrix is in a form of a film. In some of any of the embodiments described herein, the 3D porous graphene matrix is in a form of a continuous film.

In some of any of the embodiments described herein, a thickness of the 3D porous graphene matrix is determined by a number of layers and a thickness of each layer as described herein.

According to some of any of the embodiments described herein, the 3D porous structure, by being formed by subjecting a carbonaceous material to laser irradiation, comprises a 3D porous matrix that comprises or consists of laser-induced graphene (LIG).

According to some of any of the embodiments described herein, a ratio of an intensity of D and G bands (ID/IG) of the 3D porous structure, as measured by Raman spectroscopy, is in a range of from 0.75 to 1.3, or 0.75 to 1.2, or 0.75 to 1.1, or from 0.75 to 1, or from 0.75 to 0.9, or from 0.8 to 1, or from 0.8 to 0.9, including any intermediate values and subranges therebetween.

It should be understood that a ratio of an intensity of D and G bands (ID/IG) in a range according to some of these embodiments is indicative of a presence of graphene, and is thus indicative of a 3D porous graphene matrix as described herein.

In some of any of the embodiments described herein, the 3D porous graphene matrix is laser-induced graphene. In some of any of the embodiments described herein, the 3D porous structure is devoid of graphite.

According to some of any of the embodiments described herein, the method is practiced while using as a conductive substrate a component of an electrochemical system as described herein. According to some of any of the embodiments described herein, the conductive substrate is or forms a part of current collector as described herein, and the formed 3D porous structure forms an electrode deposited on the current collector.

According to some of any of the embodiments described herein, the electrode is usable as an electrode in an electrochemical system as described herein, for example, in an alkali metal ion battery.

According to some of any of the embodiments described herein, the electrode is usable as an anode in an alkali metal ion battery.

According to some of any of the embodiments described herein, the alkali metal ion battery is a lithium-ion battery.

According to some of any of the embodiments described herein, the electrode is usable as an electrode in a lithium-ion battery.

According to some of any of the embodiments described herein, the electrode is usable as an anode in a lithium-ion battery.

According to some of any of the embodiments described herein, the method is effected at temperatures that do not exceed 200, or 250, ° C., such that a temperature at which any of the steps of the method is performed ranges from room temperature (e.g., 15-25, or 20-25, ° C.) to 200 or 250° C.

According to an aspect of some embodiments of the present invention there is provided an electrochemically active component as defined and described herein, which comprises a 3D porous structure (e.g., as described herein in any of the respective embodiments), which comprises a (e.g., continuous) 3D porous graphene matrix (e.g., as described herein in any of the respective embodiments), having an electrochemically active material (e.g., as described herein in any of the respective embodiments) dispersed and/or embedded and/or entrapped therewithin.

According to an aspect of some embodiments of the present invention there is provided an electrochemically active component obtained by the method as described herein in any of the respective embodiments.

According to an aspect of some embodiments of the present invention there is provided an electrochemically active component comprising a 3D porous structure which comprises a continuous 3D porous graphene matrix having an electrochemically active material dispersed and/or entrapped therewithin.

According to some of any of the embodiments described herein, the electrochemically active component comprises a conductive substrate, and the 3D porous structure is deposited onto at least a portion of a surface of the conductive substrate.

According to some of any of the embodiments described herein, the electrochemically active component is or comprises an electrode as described herein in any of the respective embodiments and in any combination thereof.

In some of any of the embodiments described herein, the electrode is in an electric communication with a current collector. In exemplary embodiments, the electrode deposited on the current collector as described herein in any of the respective embodiments.

According to some of any of the embodiments described herein, the conductive substrate is a current collector, and the electrochemically active component is or comprises an electrode deposited on the current collector.

According to some of any of the embodiments described herein, the continuous 3D porous graphene matrix is or comprises a laser-induced graphene.

According to some of any of the embodiments described herein, the laser-induced graphene is obtained by exposing a mixture comprising a carbonaceous material and particles of an electrochemically active material to a laser irradiation as described herein in any of the respective embodiments.

Herein throughout, a “3D porous structure”, a “porous structure”, a “3D structure”, “a composite”, a “composite structure”, and variations thereof are all used interchangeably to describe the structure formed by a method as described herein.

According to an aspect of some embodiments of the present invention there is provided an electrochemical system comprising the electrochemically active component as described herein in any of the respective embodiments.

Herein throughout, the term “electrochemical system” describes any configuration that comprises at least one electrode, a power source, and a substance that undergoes redox (reduction-oxidation) reactions. An electrochemical system typically further comprises an electrolyte to facilitate ion movement between electrodes. The term “electrochemical system” encompasses various configurations, including but not limited to electrochemical half-cells, full cells, fuel cells, and batteries.

Electrochemical systems that comprise graphene can serve multiple functions, depending on their design and application. Non-limiting examples for possibly suitable applications of electrochemical systems that comprise graphene include electronics and semiconductors, energy storage, sensors, composites, thermal management, water filtration, and medical applications.

As used herein, the phrase “electronics and semiconductors” describes devices or materials that manipulate electric current for various functions, including computing, sensing, and power management. Non-limiting examples include transistors, transparent conductors, and flexible electronics.

As used herein, the phrase “energy storage” describes systems or devices that capture energy for use at a later time, typically by converting energy into a chemical or electrical form. Non-limiting examples include supercapacitors and batteries.

As used herein, the term “sensor” describes a device that detects or measures a physical property or chemical composition and converts this information into a signal that can be read or interpreted. Non-limiting examples include electrochemical sensors, chemical sensors, and biosensors.

As used herein, the term “composites” describes materials made from two or more different substances that, when combined, produce a material with enhanced properties. Non-limiting examples include structural materials and conductive inks.

As used herein, the phrase “thermal management” describes the control and dissipation of heat in electronic devices or systems to maintain optimal operating temperatures. Non-limiting examples include heat spreaders and thermal interface materials.

As used herein, the phrase “water filtration” describes processes or materials used to remove impurities or contaminants from water, making it suitable for specific uses. Non-limiting examples include graphene oxide membranes for desalination and water purification.

As used herein, the phrase “medical applications” describes the use of materials or devices in healthcare for diagnosis, treatment, or prevention of diseases. Non-limiting examples include drug delivery systems and tissue engineering scaffolds.

Electrochemical systems that comprise a graphene matrix that have the electrochemically active material dispersed and/or entrapped and/or embedded therewithin can serve multiple functions, depending on their design and application. Non-limiting examples for the possible application of electrochemical systems include energy storage devices (batteries), sensors, fuel cells, electrolyzers, electrosynthesis systems, photovoltaics, thermal management materials, flexible electronics, and structural composites.

As used herein, the phrase “energy storage device” describes a system or apparatus that stores electrical energy for later use, typically by converting and storing energy in a chemical form. Non-limiting examples include batteries, supercapacitors, and flywheels.

As used herein, the term “sensor” describes a device that detects or measures a physical property or chemical composition and converts this information into a signal that can be read or interpreted. Non-limiting examples include electrochemical sensors and biosensors.

As used herein, the phrase “fuel cell” describes an electrochemical cell that converts the chemical energy of a fuel, such as hydrogen, directly into electricity through redox reactions, typically involving an oxidizing agent like oxygen. Non-limiting examples include proton exchange membrane (PEM) fuel cells, solid oxide fuel cells (SOFCs), and alkaline fuel cells.

As used herein, the term “electrolyzer” describes a device that uses electrical energy to drive a non-spontaneous chemical reaction. Non-limiting examples include proton exchange membrane (PEM) electrolyzers, alkaline electrolyzers, and solid oxide electrolyzers.

As used herein, the phrase “electrosynthesis system” describes an apparatus or system that uses electrical energy to drive chemical synthesis processes. Non-limiting examples include systems for electrochemical reduction of CO₂, electrochemical polymerization, electroorganic synthesis, photovoltaics, thermal management materials, flexible electronics, and structural composites.

As used herein, the phrase “photovoltaics” describes technology that converts light into electricity using semiconductor materials. Non-limiting examples include solar cells and photovoltaic modules.

As used herein, the phrase “thermal management materials” describes materials designed to control and dissipate heat in electronic devices or systems. Non-limiting examples include heat spreaders and thermal interface materials.

As used herein, the phrase “flexible electronics” describes electronic devices or components that are bendable or stretchable, allowing them to be used in non-rigid applications. Non-limiting examples include flexible batteries and supercapacitors.

As used herein, the phrase “structural composites” describes materials made by combining two or more distinct materials to create a product with enhanced mechanical, thermal, or electrical properties. Non-limiting examples include reinforced materials used, e.g., in aerospace and automotive industries.

A 3D porous graphene matrix and silicon as an electrochemically active material are usable is electrochemical systems such as alkali metal ion batteries.

According to some of any of the embodiments described herein, the electrochemical system is or forming a part of an alkali metal ion battery.

As used herein and in the art, the phrase “an alkali metal ion battery” describes a type of rechargeable battery in which the ions of an alkali metal, such as lithium, sodium, or potassium, migrate between the anode and cathode during charging and discharging cycles. Non-limiting examples of alkali metal ion batteries include lithium-ion batteries (LIBs), sodium-ion batteries (SIBs), and potassium-ion batteries (KIBs).

According to some of these embodiments, the 3D porous structure as described herein is usable as an anode in the electrochemical system.

According to some of these embodiments, the electrochemical system further comprises lithium, in a form of metallic lithium or oxidized lithium (lithium ions).

According to some of any of these embodiments described herein, the electrochemical system further comprises an alkali metal ion cathode.

As used herein and in the art, the phrase “alkali metal ion cathode” describes the electrode in an alkali metal ion battery that hosts the alkali metal ions during the discharge process and releases them during the charge process. Non-limiting examples of alkali metal ion cathodes include transition metal oxides (e.g., lithium cobalt oxide in lithium-ion batteries), poly-anionic compounds (e.g., sodium iron phosphate in sodium-ion batteries), Prussian blue analogs (e.g., potassium iron hexacyanoferrate in potassium-ion batteries), NMC (lithium nickel manganese cobalt oxide, i.e., LiNiₓMn_{y}Co_{z}O₂) cathodes; lithium cobalt oxide (LiCoO₂) cathodes; NCA (lithium nickel cobalt aluminum oxide, i.e., LiNiCoAlO₂) cathodes; LMO (lithium manganese oxide, i.e., LiMn₂O₄) cathodes; LFP (lithium iron phosphate, i.e., LiFePO₄) cathodes; and lithium/sulfur cathodes.

According to some of any of the embodiments described herein, the electrochemical system further comprises a lithium-ion cathode.

Non-limiting examples of lithium-ion cathodes include NMC (lithium nickel manganese cobalt oxide, i.e., LiNiₓMn_{y}Co₂O₂) cathodes; lithium cobalt oxide (LiCoO₂) cathodes; NCA (lithium nickel cobalt aluminum oxide, i.e., LiNiCoAlO₂) cathodes; LMO (lithium manganese oxide, i.e., LiMn₂O₄) cathodes; LFP (lithium iron phosphate, i.e., LiFePO₄) cathodes; and lithium/sulfur cathodes. In exemplary embodiments, the lithium ion cathode is a lithium iron phosphate cathode.

It is expected that during the life of a patent maturing from this application many relevant cathodes will be developed and the scope of the terms “cathode” and “lithium ion cathode” are intended to include all such new technologies a priori.

According to some of any of the embodiments described herein, the electrochemical system further comprises an electrolyte.

As used herein and in the art, the term “electrolyte” describes a substance that facilitates the movement of ions between the anode and cathode during the charging and discharging cycles of the battery, enabling the flow of electric current within the system. The electrolyte can be solid, semi-solid or liquid, and can further comprise one or more additives in addition to a substance as described herein.

According to some of any of the embodiments described herein, the electrolyte is any electrolyte suitable for use in alkali metal ion batteries such as LIB.

Non-limiting examples of electrolytes suitable for lithium-ion batteries include solutions of lithium salts, such as LiPF₆, in organic solvents like ethylene carbonate (EC) and diethyl carbonate (DEC), or solid-state electrolytes like lithium sulfide (Li₂S). In exemplary embodiments, the electrolyte is or comprises LiPF₆.

Non-limiting examples of electrolyte additives include fluoroethylene carbonate (FEC) in lithium-ion batteries include vinylene carbonate (VC), ethylene sulfate (DTD, EC-S), lithium difluoro (oxalato) borate (LiDFOB), lithium bis(oxalate) borate (LiBOB), propylene carbonate (PC), sulfur-based electrolyte additives (e.g., dimethyl sulfite, ethylene sulfite), and 1,3-propane sultone (PS).

In exemplary embodiments, the electrolyte additive is fluoroethylene carbonate (FEC). Any other additives suitable for use in alkali metal ion batteries are contemplated.

Without being bound to any particular theory, the presence of such electrolyte additives facilitates the formation of a stable solid electrolyte interphase (SEI) layer, improves electrochemical stability, reduces electrolyte decomposition, and/or enhances performance under various operating conditions.

According to some of any of the embodiments described herein, the electrochemical system (e.g., cell or battery) is characterized by a cyclic stability of at least 1000, or at least 2000, or at least 3000, or at least 4000, or at least 4500, and up to 20,000, and even more, cycles, for example, from 1000 to 20,000, or from 2000 to 20,000, or from 3000 to 20,000, or from 4000 to 20,000, or from 4000 to 10,000, or from 4000 to 7000, or from 4000 to 5000, cycles, including any intermediate values and subranges therebetween.

According to some of any of the embodiments described herein, the electrochemical system (e.g., cell or battery) is characterized by an areal capacity in a range of at least 0.5, or at least 1, or at least 1.2, or at least 1.5, or at least 1.75, or at least 1.8, or at least 2.0, or at least 2.1, or at least 2.2, or at least 10, and up to 100.0, mAh/cm², for example, from 0.5 to 100, or from 1 to 10, or from 1.75 to 100.0, or from 2.0 to 100.0, or from 2.1 to 100.0, or from 2.2 to 100.0, or from 1.75 to 10, mAh/cm², including any intermediate values and subranges therebetween.

According to some of any of the embodiments described herein, the electrochemical system (e.g., cell or battery) is characterized by a gravimetric capacity of at least 500, or at least 750, or at least 1000, or at least 1200, or at least 1500, or at least 1800, or at least 2400, or at least 2200, or at least 2400, and up to 10,000, mAh/g, for example, from 500 to 10,000, or from 1000 to 10,000, or from 1200 to 10,000, or from 1500 to 10,000, or from 1800 to 10,000, or from 2000 to 10,000, or from 2200 to 10,000, or from 2400 to 10,000, mAh/g, including any intermediate values and subranges therebetween.

According to some of any of the embodiments described herein, the electrochemical system (e.g., cell or battery) is characterized by a Coulombic efficiency of at least 90, or at least 95, or at least 99, or at least 99.99, and up to 100, %, including any intermediate values and subranges therebetween.

According to some of any of the embodiments described herein, the electrochemical system (e.g., cell or battery) is characterized by a C-rate of at least 3C, or at least 3.5C, or at least 4C, and even more, and up to 10C, including any intermediate values and subranges therebetween.

As used herein and in the art, the term “C-rate” describes the rate at which a battery is charged or discharged relative to its nominal capacity. For example, at a 4C rate, a battery with a capacity of 1000 mAh would be discharged at 4000 mA, fully discharging in ¼ of an hour.

According to some of any of the embodiments described herein, the electrochemical system (e.g., cell or battery) is characterized by a capacity retention of at least 50, or at least 75, or at least 80, and up to 100, %, including any intermediate values and subranges therebetween.

According to some of any of the embodiments described herein, the electrochemical system (e.g., cell or battery) is operable at a C-rate of 3C with an average Coulombic efficiency of at least 98%, or at least 99%, or even higher, and up to 100%, including any intermediate values and subranges therebetween.

In some of any of the embodiments described herein, the electrochemical system (e.g., cell or battery) is characterized at least by an areal capacity in a range of at least 1.75, or at least 2.2, and up to 10.0, mAh/cm²; and by a gravimetric capacity of at least 2000, or at least 2400, and up to 10,000, mAh/g.

In some of any of the embodiments described herein, the electrochemical system (e.g., cell or battery) is characterized at least by an areal capacity in a range of at least 1.75, or at least 2.2, and up to 10.0, mAh/cm²; and by a Coulombic efficiency of at least 95, or at least 99, or at least 99.99, %.

In some of any of the embodiments described herein, the electrochemical system (e.g., cell or battery) is characterized at least by an areal capacity in a range of at least 1.75, or at least 2.2, and up to 10.0, mAh/cm²; and by a C-rate of at least 3C, or at least 4C, and up to 10C.

In some of any of the embodiments described herein, the electrochemical system (e.g., cell or battery) is characterized at least by a gravimetric capacity of at least 2000, or at least 2400, and up to 10,000, mAh/g; and by a Coulombic efficiency of at least 95, or at least 99, or at least 99.99, %.

In some of any of the embodiments described herein, the electrochemical system (e.g., cell or battery) is characterized at least by a gravimetric capacity of at least 2000, or at least 2400, and up to 10,000, mAh/g; and by a C-rate of at least 3C, or at least 4C, and up to 10C.

In some of any of the embodiments described herein, the electrochemical system (e.g., cell or battery) is characterized at least by a Coulombic efficiency of at least 95, or at least 99, or at least 99.99, %; and by a C-rate of at least 3C, or at least 4C, and up to 10C.

In some of any of the embodiments described herein, the electrochemical system (e.g., cell or battery) is characterized at least by an areal capacity in a range of at least 1.75, or at least 2.2, and up to 10.0, mAh/cm²; by a gravimetric capacity of at least 2000, or at least 2400, and up to 10,000, mAh/g; by a Coulombic efficiency of at least 95, or at least 99, or at least 99.99, %; and by a C-rate of at least 3C, or at least 4C, and up to 10C.

In some of any of the embodiments described herein, the electrochemical system (e.g., cell or battery) is characterized at least by an areal capacity in a range of at least 1.75, or at least 2.2, and up to 10.0, mAh/cm²; by a gravimetric capacity of at least 2000, or at least 2400, and up to 10,000, mAh/g; by a C-rate of at least 3C, or at least 4C, and up to 10C; and by a Coulombic efficiency of at least 95, or at least 99, or at least 99.99, %.

In some of any of the embodiments described herein, the electrochemical system (e.g., cell or battery) is characterized at least by a gravimetric capacity of at least 2000, or at least 2400, and up to 10,000, mAh/g; by an areal capacity in a range of at least 1.75, or at least 2.2, and up to 10.0, mAh/cm²; by a C-rate of at least 3C, or at least 4C, and up to 10C; and by a Coulombic efficiency of at least 95, or at least 99, or at least 99.99, %.

In some of any of the embodiments described herein, the electrochemical system (e.g., cell or battery) is characterized at least by a gravimetric capacity of at least 2000, or at least 2400, and up to 10,000, mAh/g; by an areal capacity in a range of at least 1.75, or at least 2.2, and up to 10.0, mAh/cm²; by a Coulombic efficiency of at least 95, or at least 99, or at least 99.99, %; and by a C-rate of at least 3C, or at least 4C, and up to 10C.

In some of any of the embodiments described herein, the electrochemical cell is characterized at least by an areal capacity in a range of at least 1.75, or at least 2.2, and up to 10.0, mAh/cm²; by a gravimetric capacity of at least 2000, or at least 2400, and up to 10,000, mAh/g; by a Coulombic efficiency of at least 95, or at least 99, or at least 99.99, %; and by a C-rate of at least 3C, or at least 4C, and up to 10C.

In some of any of the embodiments described herein, the electrochemical system is characterized at least by a cyclic stability of at least 1000, or at least 4000, or at least 4500, and up to 20,000, cycles; by a capacity retention of at least 50, or at least 75, or at least 80, and up to 100, %; and by a C-rate of at least 3C, or at least 4C, and up to 10C.

In some of any of the embodiments described herein, the electrochemical system is characterized at least by a cyclic stability of at least 1000, or at least 4000, or at least 4500, and up to 20,000, cycles; and by a capacity retention of at least 50, or at least 75, or at least 80, and up to 100, %.

In some of any of the embodiments described herein, the electrochemical system is characterized at least by a capacity retention of at least 50, or at least 75, or at least 80, and up to 100, %; and by a C-rate of at least 3C, or at least 4C, and up to 10C.

In some of any of the embodiments described herein, the electrochemical system is characterized at least by a cyclic stability of at least 1000, or at least 4000, or at least 4500, and up to 20,000, cycles; and by a C-rate of at least 3C, or at least 4C, and up to 10C.

According to some of any of the foregoing embodiments, the electrochemical system is or forms a part of an alkali ion metal battery such as LIB.

Without being bound by any particular theory, it is assumed that the advantageous, efficient and even superior performance of the electrochemical systems as described herein, is attributed to, or facilitated by, integrating a 3D porous structure as described herein in any of the respective embodiments in the system.

According to some embodiments, the 3D porous structure is such that enables an increase in the volume of the electrochemically active material (e.g., silicon) therewithin, repeated breakdown and reformation of the SEI layer, which otherwise consumes lithium ions and reduces the cyclic stability of the electrochemical cell, are reduced or prevented.

Alternatively, or in addition, the 3D porous structure is such that enables a reduction in a mechanical stress that results from an increase in a volume of the electrochemically active component (e.g., the increase in silicon volume upon lithiation), by absorbing the strain by interconnected pores of the 3D porous structure, and thereby reduces or prevents the SEI layer from cracking or fracturing, which would otherwise necessitate repeated SEI reformation and result in lithium loss.

Alternatively, or in addition, the 3D porous structure is such that enables a mass transport of the electrochemically active components which is higher than a mass transport of the electrochemically active material when used alone. Assessing the mass transport of electrodes can be effected using, e.g., EIS or CV.

Alternatively, or in addition, the 3D porous structure is such that a wetting of the electrochemical system comprising same is higher than a wetting of an electrochemical cell comprising the electrochemically active material embodiments alone (in the absence of the 3D porous graphene matrix). Assessing the wetting of an electrode by an electrolyte can be effected by immersing the electrode in the electrolyte and measuring the amount of electrolyte absorbed by the electrode material and weighing the electrode before and after immersion.

According to some of the present embodiments, the electrochemically active component as described herein forms a part of an electrochemical system which is an alkali metal ion battery such as LIB. According to some embodiments, the electrochemically active component as described herein forms an anode material in an electrochemical system which is an alkali metal ion battery such as LIB.

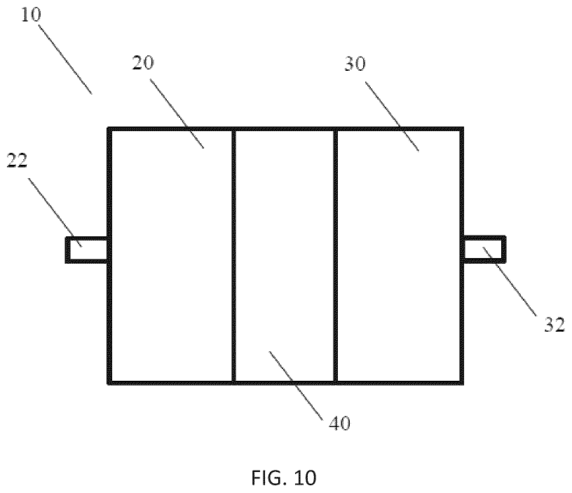

A schematic presentation of an exemplary assembly of an electrochemical cell 10 (also referred to herein interchangeably as a “full cell”), which is an alkali ion metal battery such as LIB according to some embodiments of the present invention is presented in FIG. 10.

Electrochemical cell 10 comprises a composite electrode 20 which comprises a 3D porous structure (according to any of the embodiments described herein), which acts as an anode material. Electrochemical cell 10 further comprises a cathode 30, which may be or comprise any suitable cathode material known in the art (e.g., for a lithium ion cell; e.g., a cathode according to some of any of the embodiments described herein), as described herein in any of the respective embodiments. Electrode (anode) 20 (e.g., electrochemically active component as described herein in any of the respective embodiments) and/or cathode 30 (e.g., cathode as described herein in any of the respective embodiments) may optionally further comprise a conductive coating.

Electrochemical cell 10 further comprises an electrolyte 40, which may be a solid and/or liquid electrolyte (e.g., according to some of any of the embodiments described herein), between electrode (anode) 20 and cathode 30, and optionally in contact or in electric communication with electrode (anode) 20 and/or cathode 30.

Electrochemical cell 10 optionally further comprises current collector 22 (e.g., current collector as described herein in any of the respective embodiments) configured for electrically connecting anode 20 to an electrical device to be powered by electrochemical cell 10 and/or current collector 32 is configured for electrically connecting cathode 30 to an electrical device electrical circuit to be powered by electrochemical cell 10. Current collectors 22 and/or 32 (e.g., current collector as described herein in any of the respective embodiments) may optionally be configured for secure electrical contact with standard configurations (e.g., in commercial devices) for holding power sources such as batteries.

A plurality (not shown) of electrochemical cells 10 may optionally be configured in series (e.g., so as to obtain a voltage corresponding to the sum of the voltages of the individual cells), optionally encased within a single casing to form a battery.

An electrochemical cell according to the present embodiments can follow any of the designs known in the art, and can include one or more anodes and/or cathodes. Exemplary designs include, without limitation, rotating disk-ring electrodes, ultramicro-electrodes, or screen printed electrodes.

The configuration of the components of electrochemical cell 10 as presented in FIG. 10 are for illustrative purpose only and are not to be regarded as limiting in any way.

In some of any of the embodiments described herein, an energy density of a lithium ion battery is at least 150, or at least 200, or at least 250, or at least 275, or at least 300, or at least 325, or at least 350, and up to 3,500, Wh/kg (watt-hours per kg). In comparison, energy densities of commercial lithium ion batteries are typically in a range of from 150 to 250 Wh/kg.

In some of any of the embodiments described herein relating to a lithium ion battery, the lithium ion battery is rechargeable, i.e., designed and/or identified for re-use upon recharging the battery by application of a suitable electric potential.

According to an aspect of some embodiments of the present invention there is provided a method of preparing an electrochemical system as described herein in any of the respective embodiments. According to some of these embodiments, the method is effected by preparing the electrochemically active component as described herein in any of the respective embodiments; and integrating the electrochemically active component at least with a complementary electrode and an electrolyte, thereby preparing the electrochemical cell. Integrating can be effected by assembling the electrochemically active component (e.g., a current collector having an anode material deposited thereon) with other components in the system, using methods well known in the art. See, e.g., FIG. 4B

According to some of any of the embodiments described herein, preparing the electrochemically active component is effected by additive manufacturing (AM), which is also referred to herein and in the art as 3D-printing or 4D-printing.

According to some of any of the embodiments described herein, one or more of the electrochemically active component, the complementary electrode, the electrolyte, and the current collector, each is as described herein in any of the respective embodiments, are prepared by additive manufacturing.

In some embodiments, one or more of the electrochemically active component, the complementary electrode, the electrolyte, and the current collector, each is as described herein in any of the respective embodiments, is/are prepared by additive manufacturing independently, and is/are subsequently integrated to form the electrochemical system according to some of any of the embodiments described herein. In some such embodiments, each of the electrochemically active component, the complementary electrode, the electrolyte, and the current collector is prepared independently and the components are subsequently assembled to form the electrochemical system. In some of any of the embodiments described herein, each of the electrochemically active component and at least the complementary electrode and the electrolyte is prepared by additive manufacturing, and subsequently integrated to form the electrochemical system according to some of any of the embodiments described herein. Alternatively, one or more of the electrochemically active component, the complementary electrode, the electrolyte, and the current collector are prepared by AM altogether in a single pass.

Additive manufacturing is process that is generally effected by sequentially forming a plurality of layers in a configured pattern corresponding to the shape of the object, thereby forming the object. In some AM methodologies, formation of each layer is effected by forming a layer of an uncured building material, and exposing the uncured building material to a curing condition to thereby form a hardened (cured) material.

Herein throughout, the phrase “building material” encompasses the phrases “uncured building material” or “uncured building material formulation” and collectively describes the materials that are used to sequentially form the layers, as described herein. This phrase encompasses uncured materials which form the final object, namely, one or more uncured modeling material formulation(s), and optionally also uncured materials used to form a support, namely uncured support material formulations. The building material can also include non-curable materials that do not undergo (or are not intended to undergo) any change during the process.

The building material is also referred to herein interchangeably as “printing medium”.

An uncured building material can comprise one or more modeling material formulations, and can be used in the AM such that different parts of the object are made upon hardening (e.g., curing) of different modeling formulations, and hence are made of different hardened (e.g., cured) modeling materials or different mixtures of hardened (e.g., cured) modeling materials.

The method of the present embodiments manufactures three-dimensional objects in a layerwise manner by forming a plurality of layers in a configured pattern corresponding to the shape of the object.

Each layer is formed by an additive manufacturing apparatus which scans a two-dimensional surface and patterns it. While scanning, the apparatus visits a plurality of target locations on the two-dimensional layer or surface, and decides, according to a pre-set algorithm, for each target location or a group of target locations, whether or not the target location or group of target locations is to be occupied by a building material, and which type of a building material is to be delivered thereto, or whether or not the building material is cured. The decision is made according to a computer image of the surface.

When the AM is by three-dimensional inkjet printing, an uncured building material, as defined herein, is dispensed from a dispensing head having a set of nozzles to deposit building material in layers on a supporting structure. The AM apparatus thus dispenses building material in target locations which are to be occupied and leaves other target locations void. The apparatus typically includes a plurality of dispensing heads, each of which can be configured to dispense a different building material (for example, different modeling material formulations, each containing a different curable material; or each containing a different concentration of a curable material, and/or different support material formulations). Thus, different target locations can be occupied by different building materials (e.g., a modeling formulation and/or a support formulation, as defined herein).

The final three-dimensional object is made of the hardened modeling material or a combination of hardened modeling materials or a combination of hardened modeling material/s and support material/s or modification thereof (e.g., following curing). All these operations are well-known to those skilled in the art of additive manufacturing (also known as solid freeform fabrication).

In some of any of the embodiments described herein, the current collector as described herein in any of the respective embodiments is prepared by AM in a configured pattern (e.g., by FFF as defined hereinbelow). In alternative embodiments, a pre-made is used as a conductive substrate as described herein.

In some of any of the embodiments described herein, at least one layer of the mixture (as described herein in any of the respective embodiments) are formed in a configured pattern on the current collector, and are exposed to laser irradiation.

In some of any of the embodiments described herein, the current collector as described herein in any of the respective embodiments is prepared by AM in a configured pattern, and at least one layer of the mixture (as described herein in any of the respective embodiments) is formed in a configured pattern on the current collector, and are exposed to laser irradiation.

In alternative embodiments, a pre-made current collector is used as a conductive substrate as described herein, and at least one layer of the mixture (as described herein in any of the respective embodiments) are formed in a configured pattern on the current collector, and are exposed to laser irradiation.

It is to be understood that upon performing AM-based methods an electrochemically active component (e.g., anode) is obtained, and can either be integrated in an electrochemical system, or AM of additional components can be sequentially performed.

In some of any of the embodiments described herein, an electrolyte material is prepared by AM, for example, by layerwise depositing the electrolyte material in a configured pattern. In alternative embodiments, a matrix that can thereafter be doped or soaked with the electrolyte is prepared by AM.

In some of any of the embodiments described herein, a cathode and a (cathodic) current collector is/are prepared by AM in a configured pattern. In alternative embodiments, a cathode is prepared by AM in a configured pattern, and a pre-made (cathodic) current collector is used.

An exemplary AM process according to some embodiments of the present invention starts by receiving 3D printing data corresponding to the shape of the respective one or more components in a system as described herein. The data can be received, for example, from a host computer which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY), Digital Imaging and Communications in Medicine (DICOM) or any other format suitable for Computer-Aided Design (CAD).

In some of any of the embodiments described herein, the building material (e.g., the printing medium) comprises modeling material formulation(s) (a mixture comprising a carbonaceous material and an electrochemically active material as those are described herein) and optionally support material formulation(s), and all are selected to include materials or combination of materials that do not interfere with the electrochemical and/or structural features of the 3D porous structure.

In some embodiments, a printing system for effecting a printing process/method as described herein is configured so as to allow formation of the layers under conditions that do not significantly affect structural and/or functional properties of the formed 3D porous structure.

In some of any of the embodiments described herein, the additive manufacturing (e.g., printing) process and system are configured such that the process parameters (e.g., temperature, shear forces, shear strain rate) do not interfere with (do not substantially affect) the functional and/or structural features of the formed 3D porous structure.

In some of any of the embodiments described herein, the additive manufacturing process (the printing) is performed at a temperature in a range of from room temperature and up to 200, or up to 250, ° C., including any intermediate values and subranges therebetween.

In some of any of the embodiments described herein, the above-indicated temperatures/temperature ranges are the temperatures at which the building material (e.g., at least a modeling material formulation that comprises a carbonaceous material and an electrochemically active material as those are described herein) are dispensed, that is, a temperature of a dispensing head in the AM system and/or a temperature at which the modeling material formulation is maintained prior to passing in the dispensing head.

In some of any of the embodiments described herein, the additive manufacturing process (printing) is performed while applying a shear force that does adversely affect structural and/or electrochemical properties of the formed 3D porous structure). Applying the shear force can be effected by passing the building material (e.g., at least a modeling material formulation that comprises a carbonaceous material and an electrochemically active material as those are described herein) through the dispensing head, and is to be regarded also as subjecting the building material to shear force.

The following describes exemplary AM printing methodologies that are usable in the context of embodiments of the present invention.

A printing method and a corresponding system can be any of the methods and systems known in the art for performing additive manufacturing, and exemplary such systems and methods are described hereinabove. A suitable method and system can be selected upon considering its printing capabilities, which include resolution, deposition speed, scalability, and ease-of-use.

Exemplary suitable printing systems usually contain a dispensing system (either equipped with temperature control module or at ambient temperature), and stage (a receiving medium), and a movement along the x, y and z axes directed by a CAD-CAM software. A curing source (e.g., a light or heat source) which applies a curing energy (e.g., by applying light or heat radiation) or a curing condition to the deposition area (the receiving medium) so as to promote curing of the formed layers and/or a humidifier, can also be included in the system. There are printers that use multiple dispensing heads to facilitate a serial dispensing of several materials.

Generally, printing can be effected using any of the known techniques for additive manufacturing. The following lists some exemplary additive manufacturing techniques, although any other technique is contemplated.

3D Inkjet printing: 3D Inkjet printing is a common type of 3D printer for various applications. Inkjet printers use thermal or acoustic forces to eject drops of liquid onto a substrate, which can support or form part of the final construct. In this technique, controlled volumes of liquid are delivered to predefined locations, and a high-resolution printing with precise control of (1) ink drops position, and (2) ink volume, which is beneficial in cases of microstructure-printing or when small amounts of reactive agents or drugs are added, is received. Inkjet printers can be used with several types of ink. Furthermore, the printing is fast and can be applied onto culture plates.

Extrusion printing: This technique uses continuous beads of material rather than liquid droplets. These beads of material are deposited in 2D, the stage (receiving medium) or extrusion head moves along the z axis, and the deposited layer serves as the basis for the next layer.

Stereolithography (SLA) and Digital Light Processing (DLP): SLA and DLP are additive manufacturing technologies in which an uncured building material in a bath is converted into hardened material(s), layer by layer, by selective curing using a light source while the uncured material is later separated/washed from the hardened material. SLA is widely used to create models, prototypes, patterns, and production parts for a range of industries including for printing.

Electrospinning: Electrospinning is a fiber production technique, which uses electric force to draw charged threads of polymer solutions, or polymer melts.

Fused Filament Fabrication (FFF), also known as Fused Deposition Modeling (FDM) (a trademarked term): an additive manufacturing technique where a thermoplastic filament is melted and extruded layer by layer to create a three-dimensional object.

As used herein the term “about” refers to +10% or +5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Anode Precursor Preparation and Synthesis: To ensure homogeneous mixture preparation-a slurry containing 10 mL of AZ® 1518 photoresist as an exemplary carbon precursor (carbonaceous material) according to some of the present embodiments (obtained from MicroChemicals GmbH; comprising 71% 1-methoxy-2-propanol acetate, CAS No. 108-65-6 and 15-25% novolac resin, an aromatic (phenolic) thermoplastic polymer) [MSDS of AZ®1518 Photoresist by Clariant, 2002]), and 5% by weight of SiNP (100+20 nm diameter; obtained from Nanografi) as an exemplary electrochemically active material. were mixed in an ice-bath using an ultra-sonicator for 5 minutes at a frequency of 15 kHz.

Thin layers of the slurry were spin-coated onto a standard stainless steel (316L/304) current collector (15 mm diameter, 0.5 mm thickness), and then dried over a hot-plate. The dried films were later exposed to near-UV laser irradiation (2.8 W, 450 nm; Zmorph Fab) at various lasing parameters of power, speed, defocusing, and raster spacing to create the LIG/SiNP anodes.

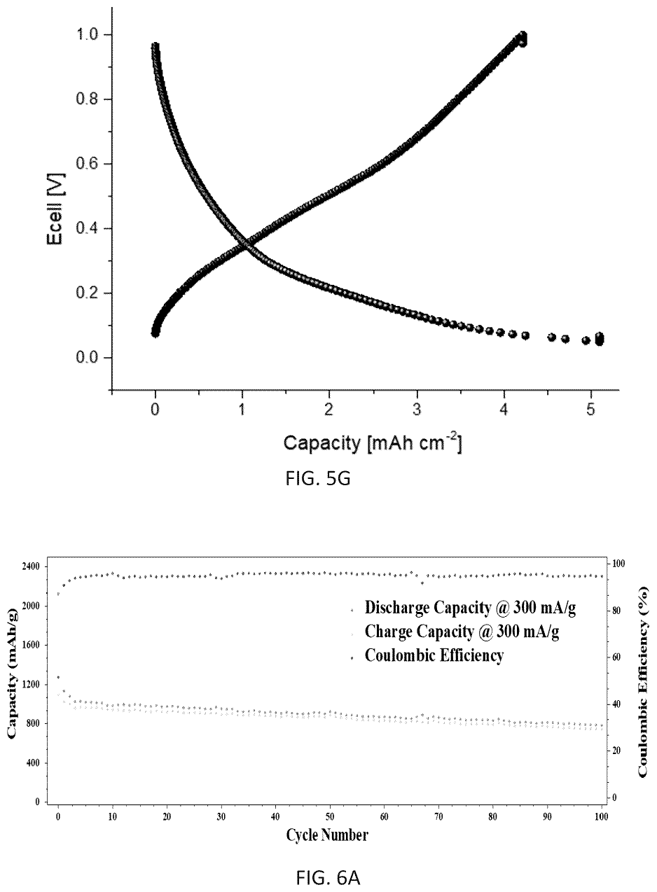

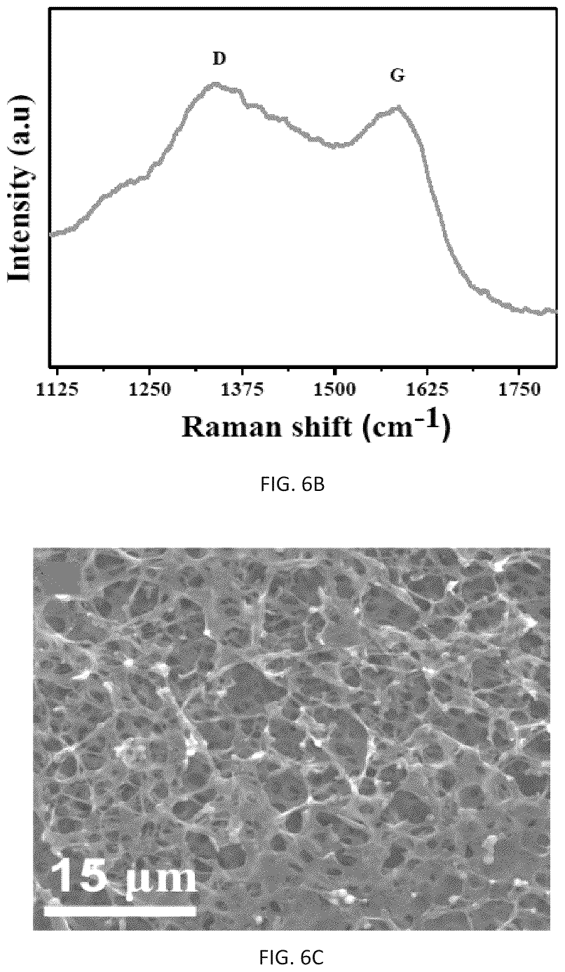

Up to 30% by weight of SiNP/resin content ratios can be applied to thereby increase cell capacity if so required, along with the preparation of one-step slurry-based single-layer deposition of higher thicknesses, by well-known slurry-based film formation approaches. 10 Chitosan-based Composite Electrode Preparation: For thin-layer chitosan-based carbon-silicon composite anode (FIGS. 6A-C): A solution of 2 wt % of chitosan (low molecular weight, Sigma Aldrich®) dissolved in 0.1 M acetic acid was prepared with a 1:1 mass ratio of silicon nanoparticles (Nanografi, average diameter 100 nm, crystalline). The relatively viscous slurry was sonicated for 20 minutes and vortexed for 5 minutes to prevent agglomeration of the silicon and homogenize the slurry. Thin layers of the slurry were spin-coated onto a 316 L stainless steel current collector (15 mm diameter, 0.5 mm thickness) at 2800 rpm for 60 seconds and then hot baked for 15 minutes at 100° C. The thin film was then treated with 20 μL of 5 wt/wt % of boric acid (>99.5%, Sigma-Aldrich®) in D.I. water and hot baked for an additional 5 minutes at 100° C. The dried film which was deposited on the current collector was then rastered with visible laser irradiation (2.8 W, 450 nm wavelength, Zmorph Fab) using lasing parameters of 100% power, 100% speed, 10 mm defocusing, and 100 μm spacing between ablation lines.

Material Characterization: Microscopy and energy-dispersive X-ray spectroscopy (EDS) images were captured using a scanning electron microscopy (Model: FEI Quanta 200 FEG, Make: Joel Co.).

Raman Spectroscopy tests of the sample were performed using the inVia™ confocal Raman Microscopy.

The sheet resistance of the anode samples was measured using a four-point probe setup (Jandel Model RM3-AR).

Transmission Electron Microscopy (TEM; Fei Themis Z G3) was performed by extracting a lamella from the sample using a ThermoFisher™ Helios 5 UC focused ion beam system (FIB), further applied for the analysis of the crystallographic structure and lattice spacing.

X-ray photoelectron spectroscopy (XPS) studies were carried out utilizing a Scanning 5600 AES/XPS multi-technique system (PHI, USA).

Electrochemical Measurements: The electrochemical performance of the graphene-silicon anodes was evaluated using CR2025 coin-cell configuration.

Half-cells were assembled in an inert glovebox (<0.1 ppm (2) using the pre-made LIG/silicon anodes, separator, and lithium metal as the counter-electrode.

The electrolyte in all experiments used was 45 μL of 85% 1 M LiPF₆ in ethylene carbonate (EC)/diethyl carbonate (DEC) (1:1) and 15% fluoroethylene carbonate (FEC; obtained from Solvay-Fluor). The separator used was a 2325 Celgard™ separator and the lithium metal discs (15 mm in diameter) were obtained from S4RTM, France.

All the assembled cells were kept at 30° C. throughout their cycling.

Electrochemical measurements were conducted using a Bio-Logic™ BCS battery cycler.

Porosity analysis of SEM imaging is conducted using ImageJ software by accounting for area fractions of binary images at identical thresholds.

### Example 1

### Composite Structure Preparation and Characterization

The development of carbon-silicon composites as electrode materials for electrochemical cells (e.g., as anode materials in lithium-ion batteries) is appealing due to their high theoretical specific capacity and potential for improving the energy density and cycle life of next-generation batteries. However, the successful application of carbon-silicon composites in lithium-ion batteries requires careful optimization during synthesizing and manufacturing to address various challenges associated with silicon's large volume expansion during lithiation and delithiation cycles, which can result in mechanical degradation and a loss of electrical contact with the current collector.

The present inventors have conceived preparing silicon-containing composite structures which can serve as electrode (e.g., anode) material in Lithium ion batteries, while utilizing a laser-induced graphene methodology.

To ensure the best possible electrochemical performance, the preparation of LIG/SiNP electrodes (e.g., anodes) was optimized.

A schematic representation of an exemplary method for the preparation of an anode electrode according to some of the present embodiments is shown in FIGS. 1A and 4A.

Generally, a slurry of silicon nanoparticles (SiNPs) and a carbon precursor (carbonaceous material) was deposited (e.g., spin-coated) on a current collector to create a uniform thin-film, followed by irradiating under varying fluences, and was subsequently exposed to N-Methyl-2-pyrrolidone (NMP) for an extended period in order to dissolve non-reacted carbon precursor, to provide the fully irradiated material as a LIG/SiNP composite structure (e.g., anode material).

Substantially full transformation of the dried-anodes to graphene-based material is required to ensure optimal electronic conductivity between the current collector and the active material as well as to prevent the dissolution of any remaining photoresist which could cause further delamination. As such, an experiment was designed to assess the depth of the transformation as a function of the laser fluence (H, J/cm²).

Using the above general procedure, various composite structures were prepared while exposing the spin-coated carbon source/silicon particles mixture to varying laser fluences (from 2.2 J/cm² to 5.5 J/cm²), to thereby provide the anode material. Fluence was calculated as previously reported [Vivaldi et al. ACS Appl Mater Interfaces. 2021, 13 (26), 30245-30260], while taking into account the laser parameters: power, scan speed, and spot size. The results of these experiments were analyzed using high-resolution scanning electron microscopy (HRSEM) and are presented in FIG. 1B.

In terms of adhesion to the substrate, FIG. 1B shows a clear trend as the fluence increases, as only partial transformation is achieved at lower values, in which case complete or partial de-lamination occurs, possibly due to residual organic compounds.

To further understand the transformation, cross-section SEM images were taken of the samples, as depicted in FIG. 1C. In all the samples which were ablated at fluences lower than 4.4 J/cm², a partial transformation of the precursor can be detected, as laterally two distinct layers can be seen.

The upper layer of the electrode comprises the transformed material, which is more conductive in comparison with the bottom layer that comprises non-reacted carbonaceous matrix, which is more insulating in nature. A clear trend of further transformation of the material is observed upon increasing fluences. At 5.5 J/cm², a full transformation of the material is shown. These results correlate with previous reports [Duy et al. Carbon (2018) 126, 472-479] that calculated a critical fluence of 5 J/cm² as needed for LIG transformation in LIG fibers. The volume loss of the layers post-laser exposure can be attributed to degassed material that were released during the irradiation, primarily in the form of carbonaceous products.

The optimized conditions were used to create uniform composite structures (e.g., as anode materials) on a SS current collector as shown in FIG. 1D. Higher magnifications allow for better examination of the even distribution of the SiNP in the carbonaceous graphene matrix, which have an average diameter of 100±20 nm. The sheet resistance of the anode material was measured using the four-point probe technique, yielding a value of 10.95±1.21 Ω/square, which matches previously reported LIG measurements [Abdul-Aziz et al. IEEE Trans Nanotechnol. (2020), 19, 269-273; Kaur et al. Mater Sci Energy Technol. (2021) 4, 407-412]. Comprehensive four-point probe measurement results of identically prepared anodes are presented herein in Table 1.

TABLE 1

| | Sample No. | | | | | | | | | |
|---|---|---|---|---|---|---|---|---|---|---|
| | 1 | 2 | 3 | 4 | 5 | 6 | 7 | 8 | 9 | 10 |
| Sheet | 10.33 | 9.80 | 11.53 | 9.40 | 12.86 | 11.52 | 12.77 | 9.43 | 10.41 | 11.49 |
| Resistance | | | | | | | | | | |
| [Ω/square] | | | | | | | | | | |
| Average Sheet | 10.95 ± 1.21 | | | | | | | | | |
| Resistance | | | | | | | | | | |
| [Ω/square] | | | | | | | | | | |

Further effort went into examining the scalability of the process via homogenous covering of large pieces of aluminum foil followed by direct lasing. A pre- and post-lasing piece of foil measuring 10 cm (diameter) are shown in FIG. 1E. By optimizing various parameters during the spin-coating process, a layer can be applied on the significantly larger surface while maintaining complete homogeneity. Identical irradiation parameters were used on the sample to finalize the anode synthesis, resulting in a ready-to-use LIG/SiNP composite electrode, which can be cut, rolled, or used as-is, e.g., in varied battery or electrochemical cell configurations.

To determine the durability of the prepared anode for bend-requiring applications such as cylindrical cells, a large piece underwent severe bend and twist-like procedures (shown in FIG. 1F) and was examined in HRSEM to check for visible defects, exhibited in FIG. 1G. FIG. 1G shows no damage was caused to the lased material due to bending. Although the strip underwent severe mechanical strain, no damage was detected, and the anode remained unaffected by the process.

To demonstrate the reduction in carbon mass, an in-operando measurement was taken by continuously weighing the 3D porous structure (prepared without SiNP) during the laser ablation process. The experimental setup is presented in FIG. 1H and the results, shown in FIG. 1I, indicate weight loss of about 70% upon ablation completion.

To further bolster the evidence of successful implementation of scale-up processes, large rectangle anodes were prepared via doctor blading the slurry on Cu current collector, as shown in FIG. 1J. This was followed by the optimized lasing conditions which provided fluence of 5.5 J/cm². Furthermore, electrochemical testing were applied to cells composed of the exemplary anodes pre- and post-mechanical testing, shown in FIG. 1K. The data, presented in FIG. 1L, indicate little to no effect of the bending on the anode's performance when integrated in an electrochemical device.

To characterize the composite structure, and to achieve a complete understanding of the distribution of SiNP in the LIG matrix, a lamella was extracted from a fully rastered sample which was prepared by spin-coating a mixture of AZ® 1518 and silicon on a stainless steel (SS) current collector, and the sample was analyzed using TEM.

The results, presented in FIG. 2A, show the surface from which the lamella was extracted (left image), as well as the lamella itself (right image), taken via a focused ion beam (FIB) which was used to perform the extraction. The highly porous and 3-dimensional nature of the sample is clearly visible, as well as the uniform transformation across the material, all providing a structure which allows for improved wetting of the electrochemically active material (silicon) during cycling of the cell.

The lamella was thinned under Ga-ion beam, and EDS mapping of the sample are shown in FIG. 2B, demonstrating the uniform distribution of Si and C, as well as the highly porous nature of the sample. EDS quantitative analysis of the same area presented in FIG. 2B (an exact acquisition location is shown in FIG. 2F) provides a deeper understanding of the ratios between the Si and C. Table 2 below summarizes EDS quantitative analysis of the anode composition based on the TEM image of FIG. 2F.

TABLE 2

| | Atomic | Atomic | Weight | Weight |
|---|---|---|---|---|
| | Percent | Error | Percent | Error |
| Element | [%] | [%] | [%] | [%] |
| C | 42.87 | 4.11 | 25.46 | 3.35 |
| Si | 49.08 | 4.87 | 68.16 | 4.26 |
| O | 8.05 | 1.67 | 6.37 | 1.47 |

As can be seen in Table 2, Si is found at 49.08 atomic % and 68.12 weight %.

FIG. 2C shows higher magnifications, which reveal clusters of SiNP embedded in the matrix. This is also schematically illustrated in FIG. 1A. It can be seen that the SiNPs are being held together by a thin outer layer. EDS mapping analysis sheds light on the latter and reveals the structure to be core-shell in nature; where the silicon nanoparticles are fully and uniformly encapsulated with a thin carbon-based layer.

FIG. 2D presents a HRTEM image of the carbon-based matrix's outer layer, and reveals a highly crystalline structure, supported by Selected Area Electron Diffraction (SAED) which is presented in FIG. 2G. These data surprisingly indicate the retention of the properties of the exemplary electrochemically active material, silicon, post-lasing.

Analyzing the data obtained from the HRTEM image, the inter-planar distances can be calculated, as depicted in FIG. 2E. The thickness of the stacked layers was calculated using inverse fast Fourier transition. The interlayer distance of 10 layers was calculated to be about 3.24 nm, thus each layer is 0.324 nm thick, which matches graphene inter-planar distances, showcasing an unprecedented ability to transform the carbonaceous material to LIG at the presence of the SiNP.

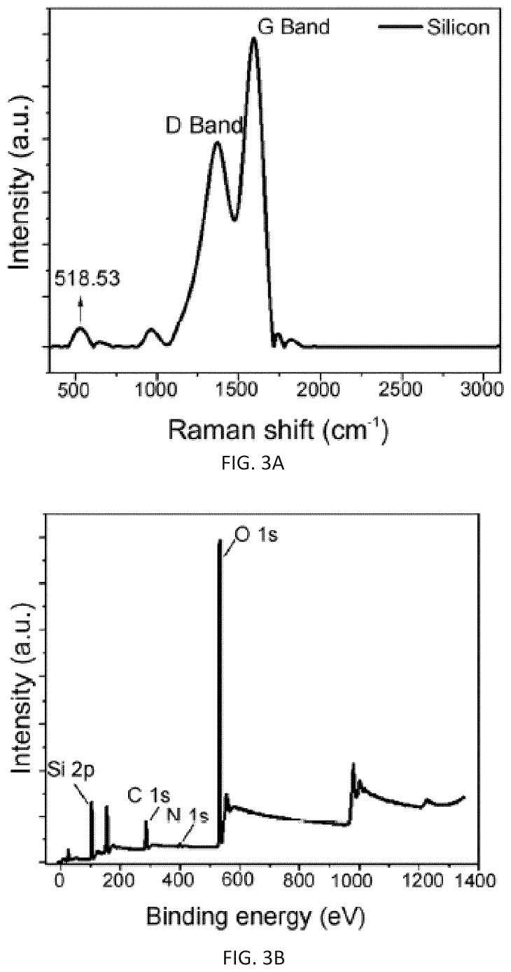

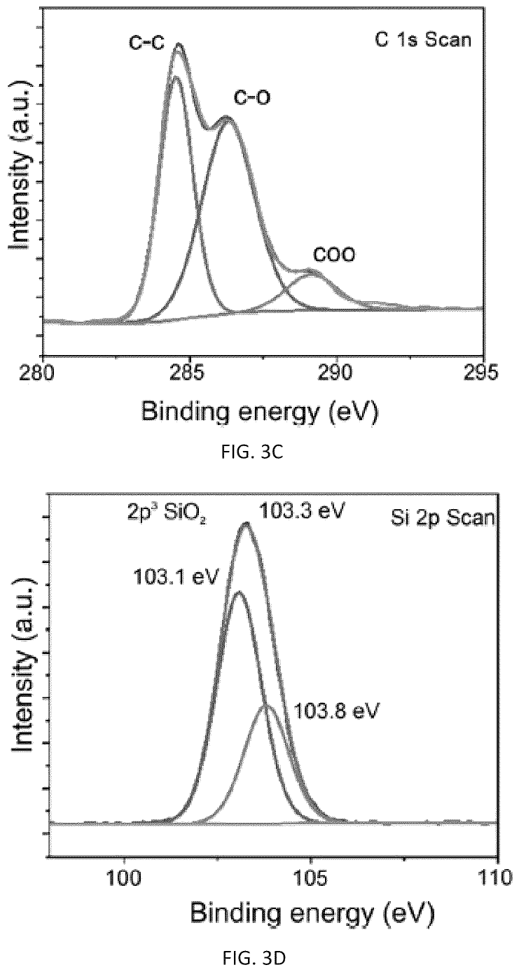

The composite surface was further analyzed using Raman spectroscopy to verify the presence of silicon and characterize the carbon species formed on the current collector and is displayed in FIG. 3A. The Raman spectra revealed two prominent peaks located between 1340 cm-1 and 1582 cm-1, corresponding to the D and G bands, respectively, and a peak at 518 cm-1 indicating the presence of silicon.

These findings provide valuable insights into the structural and chemical properties of the composite surface and further support the findings shown in FIGS. 2A-E. The observed D band is attributed to the presence of defects and amorphous-like domains in the carbon network, while the G band is indicative of the degree of graphitization. The ratio of the intensity of the D and G bands (ID/IG) reflects the level of structural defects within the carbon material, with increasing ratios indicating a greater degree of defects. Analysis of the ID/IG ratio for the present sample revealed a value of 0.86, which is indicative of graphene growth with high amount of grain boundaries and significant structural defects. These defects can be explained by the high temperatures caused by the laser rastering, as well as the high silicon content present in the matrix.

The LIG/SiNP composite was also subjected to X-ray photoelectron spectroscopy (XPS) analysis to investigate the surface chemical state and composition. The XPS survey spectrum is presented in FIG. 3B, and reveals the presence of Si, C, N, and O at binding energies of 103 eV, 285 eV, 400 eV, and 533 eV, respectively.

Curve fitting of the C 1s spectrum (FIG. 3C) revealed the presence of three chemical species at binding energies of 284.6 eV, 286.2 eV, and 289.1 eV, corresponding to C—C, C—O, and COO functional groups, respectively. Based on the binding energy, the formed material was identified as graphene oxide.

The deconvoluted Si 2p spectrum (FIG. 3D) showed the presence of three peaks in the range of 103.1-103.8 eV, indicating the presence of SiOx (0<x<2) at a binding energy of ~103.3 eV.

Overall, these data demonstrate that, surprisingly, a 3D porous graphene matrix is formed in the presence of silicon as an electrochemically active material.

### Example 2

### Cell Assembly and Electrochemical Analyses

An exemplary electrochemical cell was prepared as schematically depicted in FIG. 4A, and as follows: 250 μL of a slurry containing AZ® 1518 as an exemplary carbon precursor (carbonaceous material) and 5% by weight of SiNP was dropped onto a 15 mm diameter current collector and spin-coated at 1000 RPM for 10 seconds, followed by 3000 RPM for 30 seconds to ensure uniform coverage. The current collectors were then subjected to soft baking at 50-100° C. for 1 minute, and the spin-coating and baking processes were repeated twice more to produce a three-layer stack. Subsequently, the current collectors underwent UV lithography (laser rastering) for 9 seconds and were thereafter hard baked at 150° C. for 15 minutes. Without being bound to any particular theory, this process facilitates the release of polymeric chains within the carbon precursor, thereby aiding in the formation of optimal scaffold structures to support the silicon after laser rastering.

Following the hard bake, the samples were rastered with continuous visible laser irradiation using optimized parameters (1 mm of defocusing, 100% speed, 100% power).

The hard bake process eliminates any residual amounts of the liquid carbon precursor while simultaneously increasing the sp2 carbon content in the film, allowing for an easier conversion to LIG.

FIG. 4B depicts the assembly of a current collector onto which the composite anode (one layer) has been being deposited into a CR2032 coin cell base. A separator and an O-ring were integrated and a lithium metal disc (15 mm) and spacer were then placed after adding 42 μL of an exemplary electrolyte, LiPF₆: FEC. A cap was used to seal the battery.

Electrochemical characterization of the formed LIG/SiNP composite-containing electrochemical cell was conducted in order to assess the performance of the composite material as a potential anode in Lithium-ion battery applications.

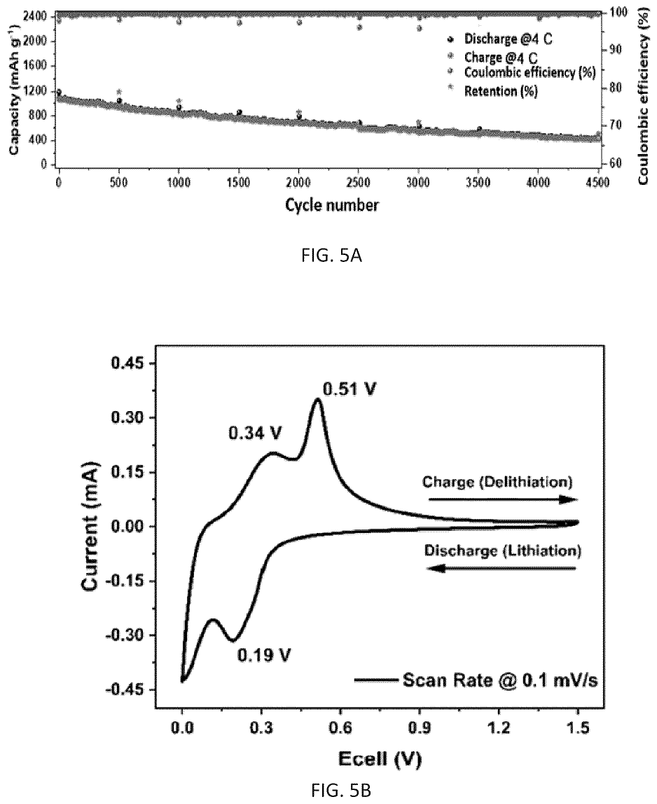

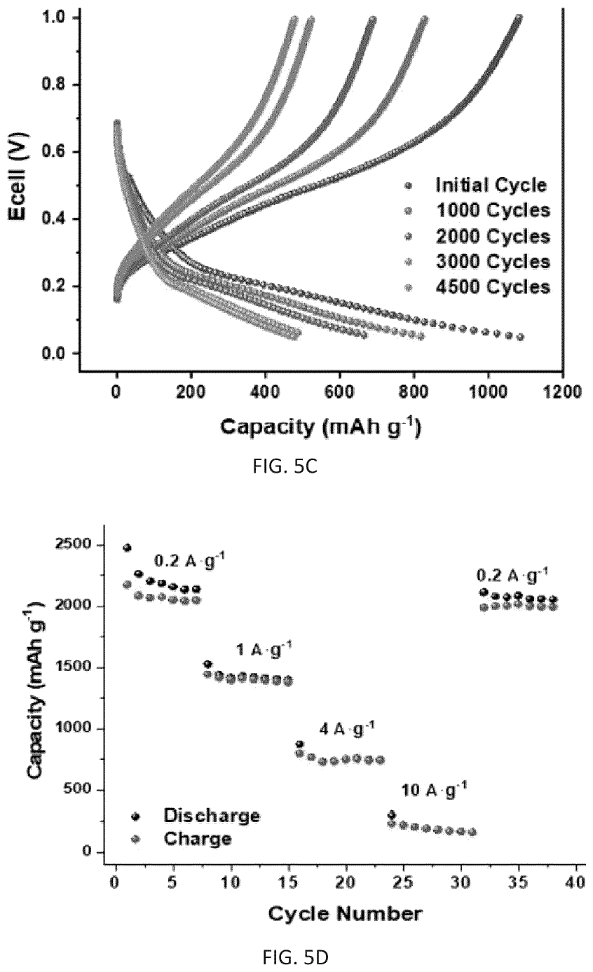

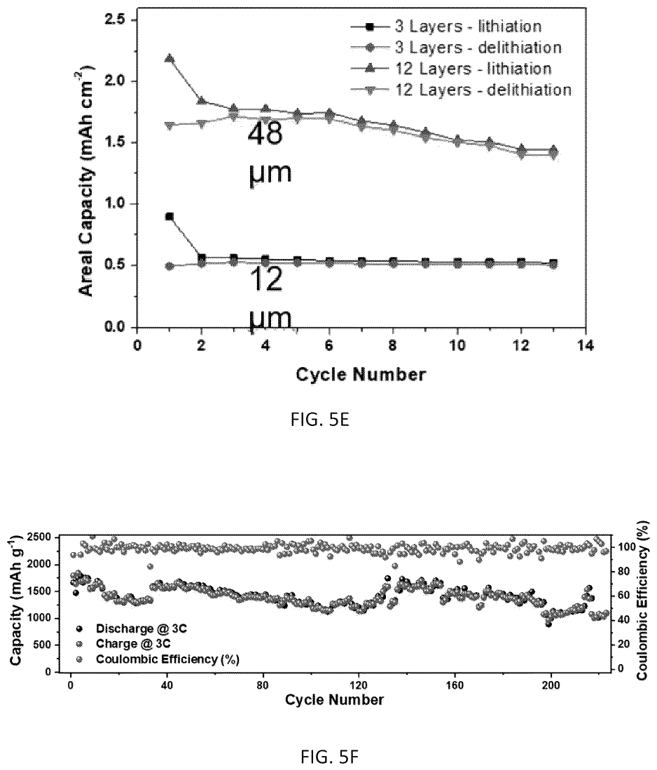

To ascertain the electrochemical reactivity of the cell, a typical cyclic voltammetry measurement was conducted between 0.05 and 1.5 V, at a scan rate 0.1 mV/see, and the results are shown in FIG. 5B. As can be seen, the cathodic (lithiation) curve shows a singular significant peak as well as a continuous rise in current near the end of the cycle, while the anodic (delithiation) curve exhibits two discrete peaks. The prominent peak observed during lithiation at approximately 0.2 Vis attributed to the initial stage of lithium insertion into the Si, corresponding to the approximate stoichiometry of Li₂Si. The sharp drop of 50 mV indicates complete stoichiometric lithiation. The two anodic peaks observed during the delithiation phase, at approximately 0.3 V and 0.5 V, are attributed to the reverse process. These cathodic and anodic behaviors are typical for silicon-based lithium-ion batteries.

In order to assess their electrochemical performance, galvanostatic cycling of the battery was performed within a potential window of from 0.05 to 1 V in accordance with the CV depicted in FIG. 5B, and the obtained data is shown in FIG. 5A.

The gravimetric capacity of the anode with respect to silicon was calculated according to the mass fraction of the spin-coated slurry and the weight of each layer after hot-baking. As shown in FIG. 5A a one-layered LIG/SiNP-containing cell cycled at extremely fast charging rate (2.5 A·g⁻¹/4C). The capacity retention and coulombic efficiency of the electrochemical cell were evaluated over 4500 cycles, showing ground-breaking cycling stability at such rates, with an impressive capacity retention of 80% and discharge capacity of approximately 951 mAh/g for the initial 500 cycles. The calculated average coulombic efficiency was over 99.99%, further corroborating the phenomenal cyclic stability of the composite with minimal loss of active material due to pulverization of the anode during lithiation/delithiation.

FIG. 5C displays voltage profiles showing that the capacity retention gradually decreases over 4500 cycles, with discharge capacities of nearly 830 mAh/g, 690 mAh/g, 560 mAh/g, and 437 mAh/g at 1000, 2000, 3000, and 4500 cycles, respectively.

Without being bound to any particular theory, it is believed that the high electrochemical cyclic stability of the 3D porous LIG/SiNP composite-containing cell can be attributed to at least some of the following reasons, and possibly to their combination:
(i) the porous structure of the composite serves to mitigate the effects of silicon volume expansion on the mechanical stability of the material and the aforementioned active material loss. The presence of pores within the composite provides ample space for the encapsulated silicon particles to expand without inducing detrimental mechanical stresses or fracturing of the solid electrolyte interface (SEI). The SEI, which forms at the electrode-electrolyte interface and buffers the electrode from further reaction with the electrolyte, is prone to repeating breakdown and reformation due to silicon volume expansion over prolonged cycling, which is deleterious to cyclic stability due to the consumption of lithium ions;
(ii) a 3D porous structure can further mitigate the recurring SEI-related phenomenon, preventing further lithium loss;
(iii) the outstanding stability displayed at an ultra-high cycling rate can be attributed to increased mass transport capabilities within the electrode and across the electrolyte due to the presence of silicon nanoparticles fully encapsulated by graphene within a larger 3D porous conductive graphene network;
(iv) the 3D porous graphene matrix enhances wetting and ion transport, leading to improved electrochemical performance. The 3D architecture allows for a greater degree of electrode-electrolyte contact, thereby facilitating more efficient ion transport across the electrode-electrolyte interface.

A C-rate performance of the exemplary LIG/SiNP cell was tested by increasing the charging/discharging rates incrementally every 8 cycles, between 0.2 and 10 A·g⁻¹ (C/3 and 16C, respectively), and the results are presented in FIG. 5D. It can be seen that even under extreme cycling conditions, when tested vs. lithium metal as the counter electrode, the anode material still exhibits high capacity values in comparison to commercially available cells. Moreover, it is shown that the extreme cycling did not negatively impact the anode material by repeating the slower cycles where the same high capacities were achieved. This further supports the superior performance of the composite, where excellent mechanical stability, unique 3D structure (as shown in FIG. 2A) and electronic conductivity of the LIG improved the performance of the active material.

The notion of improving the overall capacity of the cell via a multilayered configuration was examined by preparing two samples of spin-coated current collector, one made while depositing 3 layers of the carbonaceous material-silicon NPs slurry and one while depositing 12 layers (forming 12 micrometer or 48 micrometer thick electrode, respectively). Repeating the synthesis method, which resulted in a layer 4 μm thick. As such, electrochemical measurements were run at low C-rates to showcase the maximum capacity. FIG. 5E, which presents the areal capacity received from the aforementioned cells, shows that by multiplying the number of layers, a direct increase in capacity is observed, reaching values which are on par with desirable market targets (an areal capacity of about 1.75 mAh/cm²), while still remaining reasonably thin.

An additional cell was then assembled, consisting of 36 layers (144 μm), to explore the limits of the areal performance using this technique. Preliminary cycling at slow rates of the cell exhibited a remarkable reversible areal performance of 5.1 mAh/cm², as shown in FIG. 5G. These results demonstrate the potential of a cell containing the exemplary anode in diverse energy storage applications that require high areal capacities while concurrently maintaining thin anodes.

To further explore the applicability of the methodology, phenol formaldehyde resins (PF) was tested as a carbon source for potential matrices. A similar process was employed to form the carbon source/SiNPs slurry and the laser-induced graphene matrix. A cell was prepared using the formed matrix to assemble a PF-based battery, and its cell life is presented in FIG. 5F. These data show that a PF-based battery demonstrated an initial capacity of 1796 mAh/g, followed by a capacity retention of 71% and 60% after 100 and 200 cycles, respectively, while operating at a C-Rate of 3C with an average coulombic efficiency of 99.3%.

This PF-based electrode shines a positive light on the process as a whole for battery applications, by reducing the price further, thus improving the applicability of the process. This is indicative that using the methodology as described herein can be practiced with varying carbon sources which can be transformed to attractive LIG composites embedded with a variety of electrochemically active materials.

In an effort to further showcase the versatility of the newly designed methodology, a similar process was designed to create a 3D porous silicon-LIG electrode using chitosan as a carbonaceous material. Chitosan, the second most abundant polysaccharide on earth, is primarily derived from the shells of crustaceans. As a food-waste by-product, it is widely available.

As can be seen in FIG. 6A, the galvanostatic cycling performance of the chitosan-based anode at a current density of 300 mA/g similarly showed excellent cyclic stability with a gravimetric capacity of 780 mAh/g after 100 cycles. Raman spectroscopy and HRSEM analysis were performed and are presented in FIGS. 6B-C, respectively. FIG. 6B shows D and G peaks which indicate the formation of LIG, and the porous network is depicted in FIG. 6C.

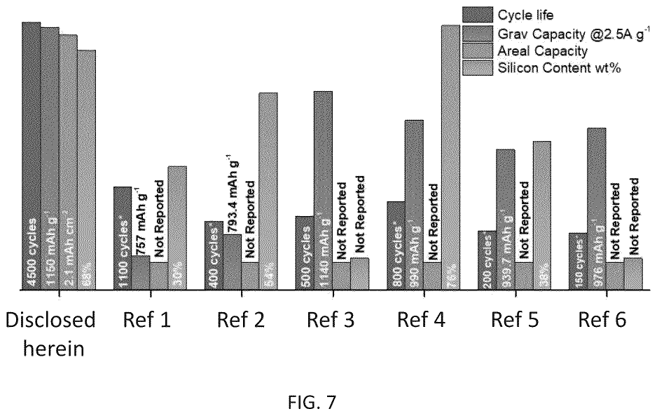

FIG. 7 presents a comparative analysis of the electrochemical performance of an exemplary lithium ion battery comprising as an anode a LIG-silicon composite structure (obtained by spin coating on SS current collector and lasing a 12-layers mixture of AZ® 1518 as an exemplary carbonaceous material and SiNP as an exemplary electrochemically active material), in comparison with lithium ion batteries as described in Chen et al., 2022, supra (“Ref 1”), Wang et al. 2020 supra (“Ref 2”), Wang et al. 2022 supra (“Ref 3”), Zhu et al. 2021 supra (“Ref 4”), Liu et al. 2023 supra (“Ref 5”), and Luo et al. 2019 supra (“Ref 6”), while focusing on cycle life at high charging/discharging rates, silicon content, gravimetric capacity, and maximum areal capacity.

The herein disclosed electrode, not only excels in cycle life at high currents when measured versus a reference electrode, but it also boasts relatively high Si content in the composite tested, as well as provides data on performance relative to the area by further modifying the thickness of the irradiated material. Notably, other works, which are not displayed in this figure, have presented high Si content anodes but show detrimental drawbacks stemming from poor electrochemical performance, short reported cycle life, or problematic methods that grossly overestimate the Si content in the anode [Wang et al. Energy Environ Sci. (2020) 13 (3), 848-858; Mu et al. Adv Sci. (2022) 9 (6), 2104685; Zhao et al. Nano Lett. (2015) 15 (12), 7927-7932]. Further, most other studies which focus on high-Si content as well as high charging/discharging rates do not report areal capacity, which raises a difficulty since this is a critical metric for evaluating the practical applicability of the anode in question for energy storage devices.

These results further cement that the herein disclosed approach offers a promising strategy for developing high-performance carbon-silicon based composite anodes with high silicon content, without compromising sustainability or relying on unsustainable carbon precursors and energy-intensive synthesis methods.

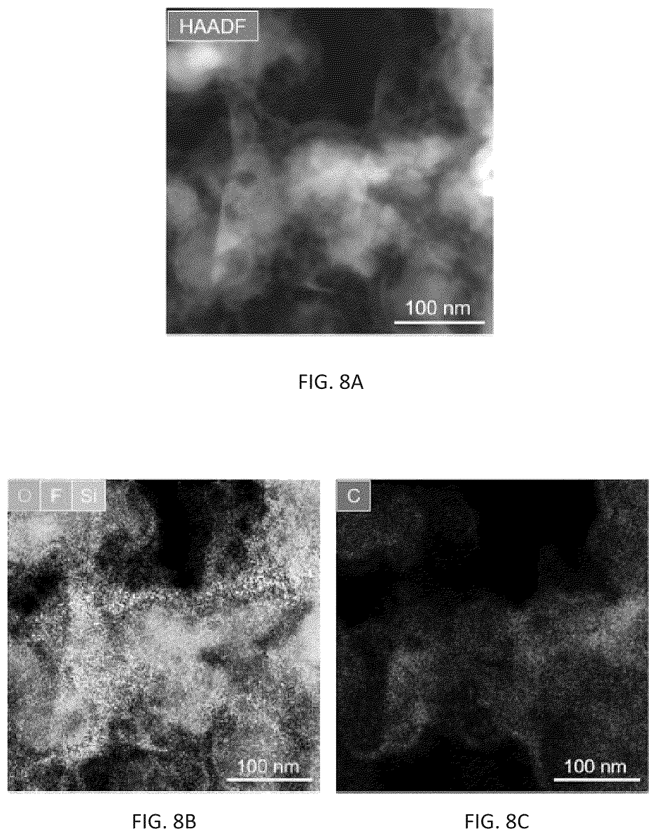

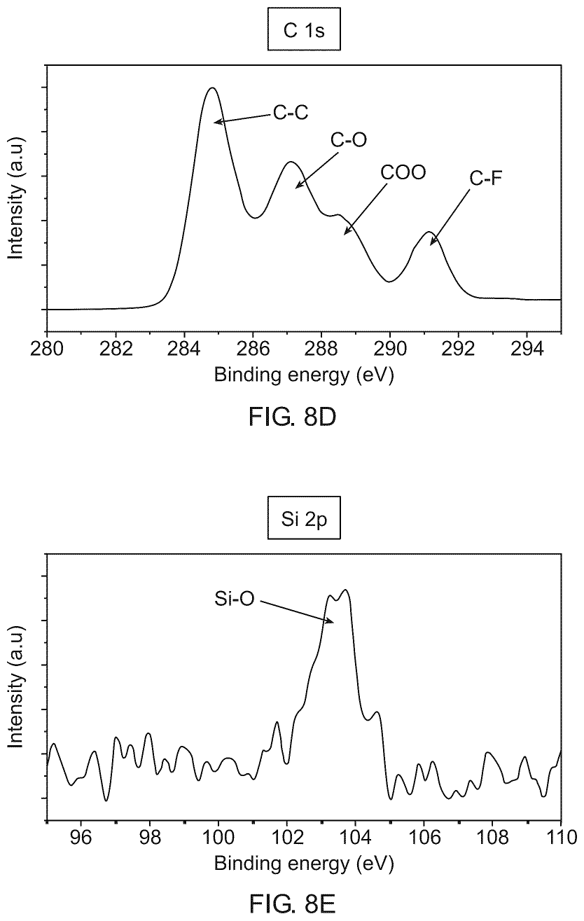

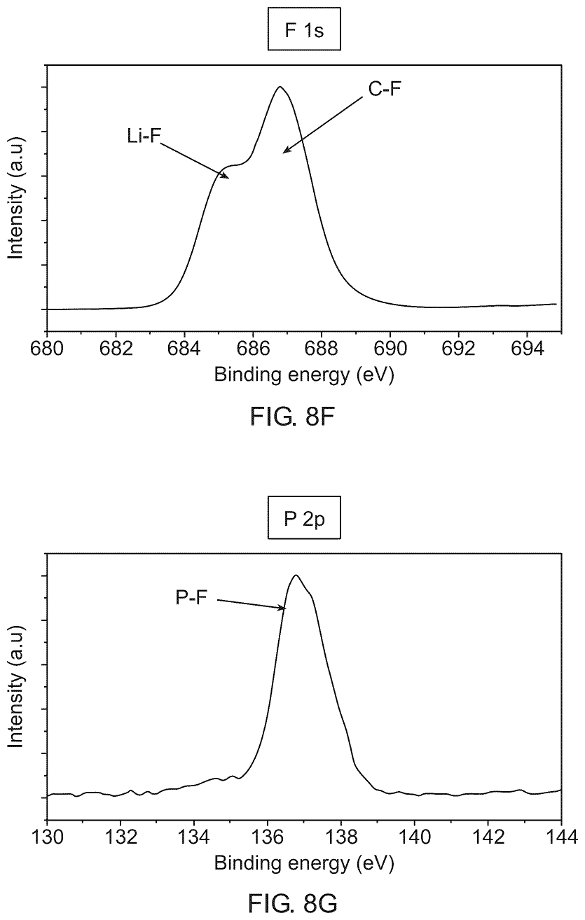

Post-mortem analysis was performed in order to evaluate the effects of cycling of LIG/SiNP anodes, as well as shedding light on various aspects of their behavior. TEM postmortem analysis of a cell identical to the one showcased in FIG. 5A allowed for detailed examination of the exemplary LIG/SiNP anodes at the nanoscale level, which further enabled the evaluation of potential any visible structural changes and degradation events that might have transpired during the cell cycling, as depicted in FIGS. 8A-C.

FIG. 8A shows TEM images that provide a comprehensive view of the LIG/SiNP anode structural evolution over cycling. When comparing these images with the TEM images in FIGS. 2A-D, minimal changes are discernible in terms of SiNP size, porosity of the matrix, and overall morphology in terms of the encapsulation of the SiNP in the carbonaceous matrix, as seen in FIGS. 8B-C.

This consistency suggests the robustness of the porous structure, which played a pivotal role in accommodating the volumetric expansion of SiNPs during cycling. The presence of pores acted as buffers, mitigating the stress induced by the expansion and contraction cycles, consequently maintaining the structural integrity of the anode. Moreover, this porous composite structure contributes to stabilizing the SEI layer. The EDS mapping in FIG. 8B provides a captivating insight by highlighting the presence of fluorine, a telltale sign of SEI formation. The highly porous matrix mitigates the ever-expanding nature of the SEI, a challenge prevalent in silicon-based anodes due to their substantial volume changes. By preventing the SEI from continuously growing, the porous architecture ensures sustained electrode performance and prolonged cycle life, further corroborating the electrochemical results shown in FIGS. 5A-F.

To explore the surface chemistry of the cycled anodes, XPS analysis of the samples was performed, and the results are presented in FIGS. 8D-G. As can be seen, while the peaks of the pre-cycled samples are still prominent (C—C, C—O, COO, and Si—O), there is evidence of change to the surface chemistry of the electrodes post-cycling. The peaks at 288.6 and 285.9 eV in the C 1s spectrum indicate the presence of carbonates. In the C Is spectra, a peak at 291.2 eV suggests the presence of C—F and P—F compounds. This is further supported by a noticeable peak at 687.5 eV in the F 1s spectra, which hints at the existence of C—F compounds. Additionally, a clear peak at 685.4 eV in the F 1s spectrum is assigned to LiF. The detection of P—F compounds is also evident from a distinct 136.8 eV peak in the P 2p spectra, which can be attributed to the adsorption of LiPF₆ on the surface.

### Example 3

### 3D or 4D Printing

The field of anodic materials faces additional challenges, and current battery production methods are in need of re-examination. Battery fabrication mostly involves assembling individual components, such as electrodes, separators, and electrolytes, into a finished product. This process can be time-consuming, costly, and resource intensive.

The new methodology disclosed herein for electrode fabrication, using carbon precursors embedded with electrochemically active materials for synthesis of LIG composite electrodes is therefore being refined and optimized to develop more practical, flexible, and customizable solutions using additive manufacturing. This methodology is paving the way to full 4D-printing of batteries as a potential solution to the challenges of traditional battery production. 4D-printing is a process that combines 3D printing with the added dimension of controlled environmental conditions inducing tunable changes in the structure. This means that batteries can be printed in a single step, with all components integrated into a single structure that can be tailored to the specific needs of a particular application. One of the key advantages of 4D-printing of full batteries is that it can significantly reduce the production time and cost compared to traditional methods. Instead of assembling multiple components separately, the entire battery can be printed in a matter of minutes. Additionally, the ability to customize the battery structure and components can lead to increased design versatility and implantation in a variety of applications.

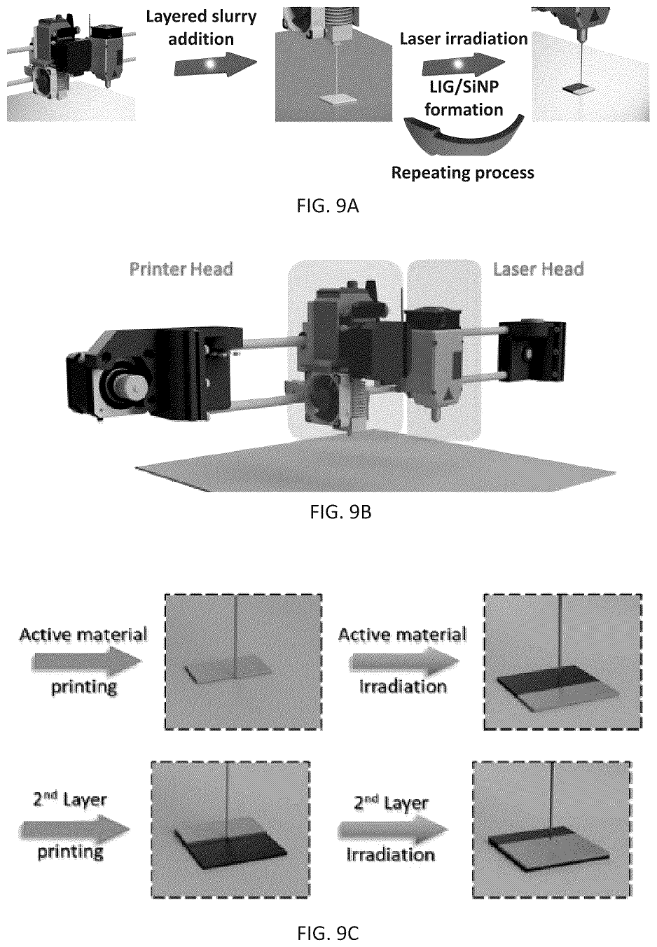

As schematically illustrated in FIGS. 9A-C, a hybrid slurry-applying-laser-irradiating system deposits multiple slurries containing different active materials onto a substrate, and the lasing processes is optimized for each targeted layer.

Using this approach, more complex and better-controlled products are achieved, and can be tailored to meet specific performance requirements. Moreover, utilizing modern fast lasing and 3D-printing technologies allows for seamless integration into the concurrent roll-to-roll electrode fabrication methods. The potential applications of this technology are vast, ranging from energy storage to the creation of advanced electronics and other high-performance materials. Overall, this technology is poised to revolutionize a wide range of industries and unlock new opportunities for innovation and advancement. The implementation of a wide range of electrochemically active materials with a vast assortment of carbon precursors can be researched in many different energy storage systems, such as lithium-sulfur, sodium-ion and potassium-ion batteries. Therefore, this work significantly contributes to the development of efficient and sustainable energy storage systems in the future and constitutes the first step towards full assembly-free 4D-printing of batteries.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of preparing an electrochemically active component, the method comprising:
depositing at least one layer of a mixture comprising a carbonaceous material and an electrochemically active material onto a conductive substrate, to thereby obtain said conductive substrate having said at least one layer deposited on at least a portion of a surface thereof; and
exposing the conductive substrate having said at least one layer deposited thereon to laser irradiation, to thereby form a 3D porous structure deposited onto said at least a portion of said surface of said conductive substrate, said 3D porous structure comprising a 3D porous graphene matrix having said electrochemically active material dispersed and/or entrapped therewithin,
thereby preparing the electrochemically active component.

2. The method of claim 1, wherein said depositing is by spin coating.

3. The method of claim 1, further comprising, subsequent to said depositing:
heating the conductive substrate having said at least one layer deposited thereon, wherein said heating is performed subsequent to depositing each of said at least one layers and/or subsequent to depositing two or more layers; and/or
heating said conductive substrate having said 3D porous structure deposited thereon.

4. The method of claim 1, wherein a total thickness of said at least one layer ranges from 1 to 200 micrometers, or from 1 to 100 micrometers.

5. The method of claim 1, wherein said laser irradiation is performed at a fluence in a range of at least 3.5, or at least 4.0, or at least 4.4, and up to 50.0, J/cm².

6. The method of claim 1, wherein said electrochemically active material is in a form of a plurality of particles having an average diameter in a range of from 1 to 300 nm, or from 1 to 200 nm, or of about 100 nm.

7. The method of claim 1, wherein said electrochemically active material is or comprises silicon.

8. The method of claim 1, wherein said carbonaceous material is selected capable of transforming to graphene following said exposure to said laser irradiation.

9. The method of claim 1, wherein said mixture comprises said electrochemically active material in an amount of at least 1%, or at least 5%, and up to 30%, by weight of a total weight of said mixture.

10. The method of claim 1, wherein an oxygen content of said 3D porous structure ranges from 1 to 10, % by weight of the total weight of said 3D porous structure, indicative of the total amount of oxidized carbon and/or silicon species in the structure.

11. The method of claim 1, wherein said conductive substrate comprises one or more of stainless steel, copper, and aluminum.

12. The method of claim 1, wherein said conductive substrate is a current collector, and wherein said 3D porous structure forms an electrode deposited on said current collector.

13. An electrochemically active component obtained by the method of claim 1.

14. An electrochemically active component comprising a 3D porous structure which comprises a continuous 3D porous graphene matrix having an electrochemically active material dispersed and/or embedded and/or entrapped therewithin.

15. The electrochemically active component of claim 14, further comprising a conductive substrate, wherein said 3D porous structure is deposited onto at least a portion of a surface of said conductive substrate.

16. The electrochemically active component of claim 14, wherein an overall porosity of said 3D porous structure ranges from 20 to 80, %, when analyzing a binary SEM image with a threshold of 127; and/or
a content of said electrochemically active material in said 3D porous structure ranges from 40 to 80, or from 50 to 70, % by weight of the total weight of said continuous 3D porous graphene matrix;
and/or a carbon content of said 3D porous structure ranges from 10 to 40, % by weight of the total weight of said continuous 3D porous graphene matrix; and/or
an oxygen content of said 3D porous structure ranges from 1 to 10, % by weight of the total weight of said continuous 3D porous graphene matrix, indicative of the total amount of oxidized carbon and/or silicon species in the structure; and/or
a ratio of an intensity of D and G bands (ID/IG) of said 3D porous structure, as measured by Raman spectroscopy, is in a range of from 0.75 to 1.1; and/or
a total thickness of said 3D porous structure ranges from 1 to 200 micrometers, or from 1 to 100 micrometers.

17. The electrochemically active component of claim 14, wherein said electrochemically active material is or comprises silicon, and said particles are or comprise silicon nanoparticles.

18. An electrochemical system comprising the electrochemically active component of claim 14.

19. A method of preparing an electrochemical system, the method comprising:
preparing the electrochemically active component according to the method of claim 1; and
integrating the electrochemically active component at least with a complementary electrode and an electrolyte, thereby preparing the electrochemical system.

20. The method of claim 19, wherein preparing the electrochemically active component is effected by additive manufacturing.
